(19) United States
(12) Patent Application Publication
(10) Pub. No.: US 2026/0113589 A1
(43) Pub. Date: Apr. 23, 2026

(54) ACOUSTIC MODELING OF DYNAMIC PORTALS

(71) Applicant: Microsoft Technology Licensing, LLC, Redmond, WA (US)

(72) Inventors: Nikunj RAGHUVANSHI, Redmond, WA (US); John Michael SNYDER, Redmond, WA (US); Michael G. CHEMISTRUCK, Issaquah, WA (US)

(73) Assignee: Microsoft Technology Licensing, LLC, Redmond, WA (US)

(21) Appl. No.: 19/080,566

(22) Filed: Mar. 14, 2025

Related U.S. Application Data
(60) Provisional application No. 63/710,782, filed on Oct. 23, 2024.

(51) Int. Cl. H04S 7/00

(52) U.S. Cl. CPC H04S 7/304; H04S 7/306; H04S 2400/11

(57) ABSTRACT

This document relates to techniques for rendering realistic sounds in a virtual scene, such as in a video game or simulation. The disclosed techniques can account for the state of various portals, such as windows or doors, in the virtual scene. The states can range from fully open to fully closed. For instance, the disclosed techniques can identify various portals that are on paths between a sound source and a listener in the virtual scene and then attenuate sound energy arriving at the listener based on the state of those portals.

### BACKGROUND

Practical modeling and rendering of real-time acoustic effects (e.g., sound, audio) for video games and/or virtual reality applications can be prohibitively complex. For instance, conventional real-time path tracing methods demand enormous sampling to produce smooth results. Alternatively, precomputed wave-based techniques can be used to accurately represent acoustic parameters (e.g., loudness, reverberation level) of a scene at low runtime costs. However, these precomputed wave-based techniques have generally been limited to static virtual scenes. In practice, however, virtual scenes can change over time. In particular, some virtual scenes have dynamic portals that can open and close at runtime, such as doors or portals.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for modeling and rendering of sound. One example includes a computer-implemented method that can include receiving space data characterizing a virtual scene that includes a plurality of portals. The method can also include deploying probes at listener locations in the virtual scene. The method can also include simulating sound energy propagation within the virtual scene from various source locations to the probes at the listener locations, the simulating being performed with the plurality of portals in at least two different states. The method can also include determining acoustic portal parameters representing how the sound energy propagation is impacted by the plurality of portals in the at least two different states. The method can also include storing the acoustic portal parameters, the acoustic parameters providing a basis for attenuating runtime sound in the virtual scene according to sound attenuation by individual portals.

Another example includes a computer-implemented method that can include receiving a source location of a sound source that emits a sound signal to a listener location of a listener in a scene having a plurality of portals. The method can also include retrieving acoustic portal parameters for the listener location, the acoustic portal parameters representing how sound energy propagation arriving at the listener location is impacted by the plurality of portals. The method can also include receiving portal attenuation values for the plurality of portals in the scene. The method can also include looking up portal paths in the acoustic portal parameters based at least on the listener location. The method can also include determining a path-based attenuation from the source location to the listener location along the portal paths according to the acoustic portal parameters and the portal attenuation values. The method can also include outputting the path-based attenuation.

Another example entails a system that includes a processor and a storage medium storing instructions. When executed by the processor, the instructions can cause the system to receive a source location of a sound source that emits a sound signal to a listener location of a listener in a scene having a plurality of portals. The instructions can also cause the system to retrieve acoustic portal parameters for the listener location, the acoustic portal parameters representing how sound energy propagation arriving at the listener location is impacted by the plurality of portals. The instructions can also cause the system to receive portal attenuation values for the plurality of portals in the scene. The instructions can also cause the system to look up portal paths in the acoustic portal parameters based at least on the listener location. The instructions can also cause the system to determine a path-based attenuation from the source location to the listener location along the portal paths according to the acoustic portal parameters and the portal attenuation values. The instructions can also cause the system to output the path-based attenuation.

The above-listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. In some cases, parentheticals are utilized after a reference number to distinguish like elements. Use of the reference number without the associated parenthetical is generic to the element. Further, the left-most numeral of each reference number conveys the FIG. and associated discussion where the reference number is first introduced.

FIG. 1 illustrates a scenario of acoustic probes deployed in a virtual scene, consistent with some implementations of the present concepts.

FIG. 2 illustrates a geometric model related to propagation of sound through a portal, consistent with some implementations of the present concepts.

FIG. 3 illustrates an example scene having multiple portals through which sound can travel, consistent with some implementations of the present concepts.

FIG. 4 illustrates a portal graph, consistent with some implementations of the present concepts.

FIG. 5 illustrates a runtime portal graph, consistent with some implementations of the present concepts.

FIG. 6 illustrates an example of runtime portal solving, consistent with some implementations of the present concepts.

FIG. 7 illustrates an example of various acoustic stages that can be used to implement the present concepts.

FIG. 8 illustrates an example system that is consistent with some implementations of the present concepts.

FIGS. 9 and 10 are flowcharts of example methods in accordance with some implementations of the present concepts.

### DETAILED DESCRIPTION

As noted above, modeling and rendering of real-time acoustic effects can be very computationally intensive. As a consequence, it can be difficult to render realistic acoustic effects without sophisticated and expensive hardware. For instance, modeling acoustic characteristics of a real or virtual scene while allowing for movement of sound sources and listeners presents a difficult problem, particularly for complex scenes. The problem becomes even more complex when accounting for changing characteristics of the scene itself.

For instance, in many applications, doors or other portals may be part of a scene and can open and close at runtime. In real life, listeners can perceive sounds propagating through a door as being increasingly attenuated as the door progressively closes. If there are multiple doors or windows between the listener and the source of the sound, then each of those doors and windows can further attenuate the sound. The attenuation by each portal increases as the portal closes and decreases as the portal opens.

For instance, consider rendering acoustic effects in a video game with a large scene (e.g., 10 square kilometers and one hundred portals), where multiple sound sources and/or listeners are moving in the scene while portals are opening and closing. At each frame, the sound sources and listeners can move, and dynamic portals can change states. Thus, in some cases, acoustic effects are updated at visual frame rates to reflect changes to the sound source, listener, and dynamic portals. Ideally, the acoustic effects account for diffraction of sound by the dynamic portals as well as static structures in the scene, while varying smoothly in time and space so that the user does not perceive discontinuities.

One high-level approach for reducing the computational burden of rendering sound involves precomputing acoustic parameters characterizing how sound travels from different source locations to different listener locations in a given virtual scene. Once these acoustic parameters are precomputed, they are invariant provided that the scene does not change. However, when dynamic portals are part of the scene, they can change state at runtime. It is computationally intensive to precompute acoustic parameters for each plausible runtime portal state of each portal, and even more computationally intensive to do so for each potential combination of portal states. Here, the term “precompute” is used to refer to determining acoustic parameters of a scene offline, while the term “runtime” refers to using those acoustic parameters during execution of an application to perform actions such as identifying rendering sound to account for changes to source location, listener location, and/or portal state of portals through which the sound travels.

The disclosed implementations offer computationally efficient mechanisms for modeling and rendering of acoustic effects that account for changing portal state. For instance, the disclosed implementations can precompute or “bake” parameters such as a static energy field, a list of portal disks, a portal graph, a cluster index field, and a face cluster list for each probed listener location. At runtime, these parameters can be employed to compute the attenuation from a runtime sound source (emitter) location to a runtime listener location over multiple paths given portal states specifying attenuation for portals in the scene.

The following describes how the disclosed techniques can be integrated into an approach that precomputes acoustic parameters using a wave solver. However, the disclosed techniques can be employed in any acoustic system, e.g., approaches that rely on ray tracing, machine learning, etc.

### Probing

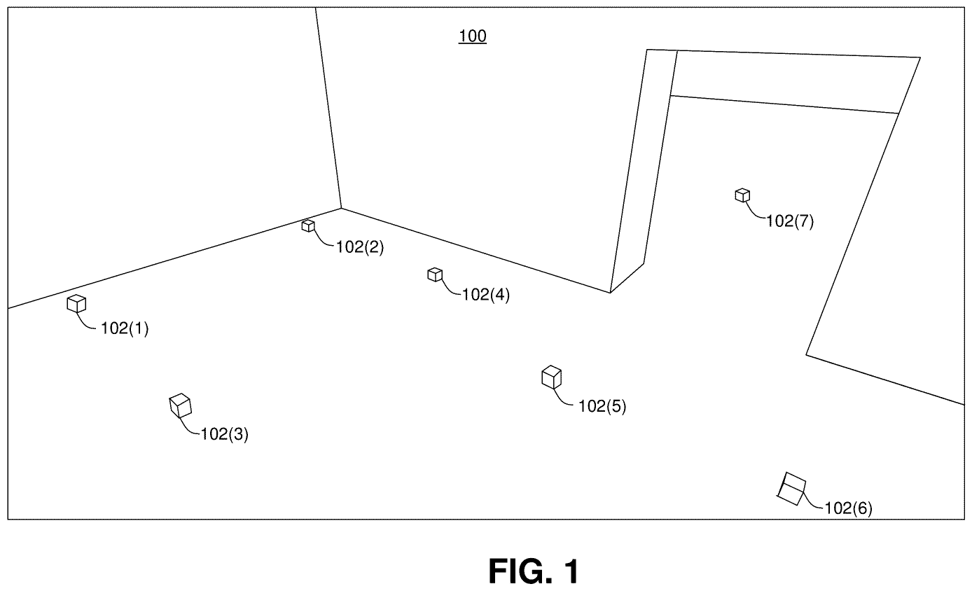

The disclosed implementations can precompute acoustic parameters of a scene and then use the precomputed information at runtime to render sound. To determine the acoustic parameters for a given virtual scene, acoustic probes can be deployed at various locations as described below. FIG. 1 shows an example of probing a scene 100. Individual probes 102(1)-102(7) are deployed throughout the scene at various locations where listeners can appear at runtime.

In some implementations, simulations can be employed to model the travel of sound between selected locations in a given scene. For instance, sound sources can be deployed at given source locations and each probe can act as a listener at the corresponding probe location. In some implementations, sound sources can be deployed in a three-dimensional grid of voxels (not shown), with one sound source in each voxel.

Two simulations can be carried out for each combination of sound sources and listener probes in the scene—one simulation with all portals in the scene in a fully open state, and another simulation with all of the portals in the scene in a fully closed state. For instance, wave simulations can be employed to model acoustic diffraction in the scene. The wave simulations can be used to determine how sound will be perceived by listeners at different locations in the scene depending on the location of the sound source and the state of the portals in the scene. Then, acoustic parameters can be stored representing this information. For instance, the acoustic parameters can include attenuation values that represent how sound is attenuated by the portals in the two simulations.

### Algorithmic Details

The following provides specific algorithmic details that can be employed to implement the disclosed concepts relating to evaluating portal state to obtain acoustic parameters that can be precomputed and employed for runtime sound rendering. As noted previously, one type of dynamic element in game scenes is dynamic portals such as doors and windows. Note that the term “dynamic portal” or simply “portal” can also encompass other aspects of scene geometry that can change at runtime. For instance, an otherwise static wall might have a particular section that can be destroyed in a video game at runtime, and that particular section of the wall can be modeled as a dynamic portal using the techniques described herein.

The following describes how these portals can be modeled as a portal network through which sound flows across a multitude of paths. Sound propagation though a portal network is affected in a complex manner, and the disclosed implementations allow for runtime rendering of sound in a manner that realistically accounts for when various doors open or close dynamically at runtime. The present concepts pertain to enabling such complex dynamic portal networks for any existing precomputed acoustic system in a “plug in” fashion. Using the following approach, precomputation can be employed to derive acoustic parameters that characterize attenuation by individual portals at runtime given information as to where the portals are located in the virtual scene. A dynamic portal can be described as a spatially-localized section of a scene's otherwise static architecture that might dynamically attenuate sound propagation through it. This dynamic attenuation can also be referred to as a transmission loss.

The following shows a specific algorithmic approach to precompute the sound propagation topology through a network of dynamic portals throughout a 3D virtual scene, and store relevant information for fast computation of their dynamic effect in real-time. Note that the disclosed concepts will work for any precomputed propagation system, with low memory and computational cost. Further, complex propagation via portal networks is modeled, where portals might act in series, parallel, or any arbitrary combination thereof, responsive to the dynamic state of all portals, and the dynamic locations of each sound and listener within a 3D scene. Further, the techniques described herein work for general 3D scenes, e.g., scenes without rooms or watertight enclosures. In addition, the present concepts can be implemented without manual room markup from the user, which takes a large amount of time with many existing systems, saving game studios cost on manual labor for scene markup. A precomputed sound propagation system can include multiple stages. For instance, one approach involves two stages: a computationally intensive precomputation (or baking) stage where the scene is analyzed and resulting data stored to persistent storage (e.g., disk), followed by a runtime stage that reads the baked data to synthesize real-time data on the propagation characteristics between input dynamic emitter and listener (e.g., player) locations. The following algorithm description is broken across these stages.

The following description uses the term “portal” to mean “dynamic portal” that can dynamically change its transmission loss at runtime. The scene might have static portals as well, but these can be modeled as part of the static geometry. The following algorithm can be employed to modify an existing “base” precomputed system. The base system can employ acoustic reciprocity by simulating a runtime listener as the sound source during precomputed acoustic simulation.

The following terminology is employed.

Base solver refers to a high-accuracy solver that is used for precomputation of acoustic parameters. The base solver can be quite expensive to run, otherwise one could just run it in real-time and obviate the need for baking. The base solver could be implemented using many techniques, such as wave-based, geometric (ray-traced), and/or using machine learning. Example base solvers are described in U.S. patent application Ser. No. 17/236,605 (“the '605 application,” Attorney Docket No. 407038A-US-CIP) and U.S. patent application Ser. No. 17/565,878 (“the '878 application,” Attorney Docket No. 410852-US-NP), both of which are incorporated herein by reference in their entirety. The base solver can be employed to determine acoustic parameters that characterize how sound is perceived at various locations in a scene.

Portal solver refers to another solver that models the effects of portal state on sound travel within the scene using a portal graph. The term “acoustic portal parameters” refers to various parameters described below that can be employed to model the impact of portal state on sound travel within the scene. The term “acoustic parameters” encompasses both acoustic portal parameters as well as other acoustic parameters that can be determined by the base solver, e.g., as described in the '605 application and the '878 application.

Energy Vector. The portal solver can be employed to dynamically modify a vector of energies produced by the base solver, where the vector is denoted E*. The superscript * is used to indicate that the underlying quantity ranges over this energy vector's components. The algorithm is agnostic to the precise meaning behind each component, except that it indicates energy. For instance, the vector might range over energies in various temporal phases of the impulse response, or over various frequency bands, or a combination, such as a spectrogram representation. The vector might also have more abstract entries such as a “filtering” value where a value of 0 represents a lot of low-pass filtering, while 1 might represent lack of low-pass filtering.

To simplify the following explanation, two components will be discussed: E*={E^{d}, E^{r}} representing “initial” (often called “dry” in audio engineering) and “reverberant” energy, respectively. Any expression with the asterisk notation can be understood as substituting values for each energy component in turn (e.g., *←{d,r}) in the entire equation, thus yielding a set of expressions.

Dynamic portal transmission losses. At every visual frame during gameplay, a user (e.g., a video game, virtual reality application, simulation application, etc.) can dynamically specify the current multiplicative attenuation, called a transmission loss, for each energy vector component of the sound as it passes through each portal to radiate from either of its sides (called “face”). This information is denoted with {α*(f)} where f indexes portal faces. Using an example with dry and reverb energy components, these would be two lists: {α^{d}(f)},{α^{r}(f)} for initial and reverb attenuations, respectively.

The transmission loss factor can be determined by the sound designer based on the type of portal and its current animation state. As an example, when a door is open {α^{d}=1, α^{r}=1} but as it progressively closes, for a steel door the value might smoothly reduce towards {α^{d}=0, α^{r}=0} when completely shut to entirely silence the sound through it when shut. On the other hand, for a wooden door, one might use {α^{d}=0.01,α^{r}=0.1} when shut to simulate muffled and unclear conversation as heard through a shut door inside a house. These choices are up to the sound designer and may be modified in real-time, including, for instance, how the attenuation varies differently for a sliding versus swinging door, or based on any artistic sound design considerations whatsoever. The techniques described herein can be agnostic to these sound design concerns to enable flexible usage in practical application scenarios.

Probes. Any precomputed system can sample possible listener locations by probing, as described previously with respect to FIG. 1. The following algorithm can modify the base system's processing for each such probe with additional computation and data. The rest of the discussion in this paper assumes any one such probe, located at x, referred to herein as “the probe.”

Simulation Volume. Some of the baked information can be stored over a finite simulation volume V(x′; x) that is centered around each probe x, sampled on a grid. The simulation volume is indexed in 3D by x′. Using acoustic reciprocity, x′ represents possible emitter locations at runtime for a listener located at x (the probe). If the base solver already employs a simulation volume per probe, then the present system can use the same simulation volume. Otherwise, the simulation volume can be determined based on the furthest portal from the listener whose dynamic occlusion should be considered at runtime, with a grid resolution that suits the application at hand. As noted above, an arbitrary probe is assumed for the following discussion, the following notation will usually drop x and use V(x′) or simply V to denote “the” simulation volume which should be understood as the simulation volume around any arbitrary probe being baked by the base system.

Static Energy Fraction Field. For each probe, the base system can add a point source at x and simulate the environment with all dynamic portals treated as fully open. The disclosed techniques can perform an additional simulation at the other extreme: all portals are fully closed. As discussed later, each portal indexed by p has an associated surface Gₚ that blocks off its opening. The base solver is invoked with the scene geometry inclusive of all portal geometries Gₚ, from the probe located at x. For instance, for a grid solver, all grid cells lying on Gₚ would be marked occupied. The material assigned to Gₚ does not necessarily have a strong impact. Some implementations model the scene using a reflective material with energy reflectivity of 0.9. This value could also be derived based on the material of the door panel.

Denote with

$${E}_{open}^{*} ( {x}^{′} ) and {E}_{closed}^{*} ( {x}^{′} )$$

respectively the energy obtained with all portals open vs closed, with x′ ranging over the simulation volume. The former is what is rendered by the unmodified base system, and the latter is the energy that arrives at the listener (x) from any emitter location (x′) without going through any portals since their opening geometry Gₚ was included in the simulation to block propagation through portals.

With that, define the static energy fraction field,

$${S}^{*} ( {x}^{′} ) = \frac{{E}_{closed}^{*} ( {x}^{′} )}{{E}_{open}^{*} ( {x}^{′} )} \qquad ( 1 )$$

in theory, 0≤S*≤1, since less energy would arrive with all portals closed than all open. However, this can be violated due to reflections from portal geometry Gₚ and/or interference effects. Thus, the disclosed concepts can clamp the upper range to 1.

The parameter S* may be understood as follows. S*→1 when the emitter and listener, {x′, x} are in the same space, so that portals do not strongly influence propagation, such as when they are outdoors with line of sight x′→x. On the other extreme, S*→0 when {x′, x} straddle a watertight room so that all acoustic paths connecting {x′, x} must go via dynamic portals. S* will take on some intermediate value when {x′, x} straddle a broken room and there are thus paths that can go via portals as well as those that can wrap around static geometry. So (1−S*) may be understood as the degree of influence the portal network has on sound propagation between a pair of points in the scene.

This parameter allows the disclosed techniques to support general scenes including non-water-tight rooms. Systems that rely on water-tight buildings implicitly assume S* is binary: either 0 or 1 indicating that either all energy between emitter and listener must be treated by dynamic portals, or none of it, without any gradual variation between the two extremes that general scenes may involve.

Composing base and portal solvers. The following describes how to combine any base, static solver's results with the disclosed dynamic portal solver. The idea is general, only assuming a portal solver that presumably trades off the base solver's accuracy for real-time performance that incorporates dynamic attenuation from portals.

Using dynamic portal transmission losses, α*(f), the portal solver approximates the energy attenuation from any emitter location, x′ to a listener (e.g., a game player) at x in real-time, with locations dropped here for brevity. The portal solver is discussed further below. Assume the portal solver predicts the energy vector ε*({α*}) given current transmission losses. This value could be used directly for audio rendering but that does not fully leverage the accurate simulation of the base solver. Instead, the portal solver is queried in the absence of transmission loss from any portal, denoted E({1}), where the argument is to be understood as setting α*(f)=1,∀f.

This can be employed to compute the global, dynamic relative attenuation due to the portal network:

$${β}^{*} ( \{ {α}^{*} \} ) = \frac{{ε}^{*} ( \{ {α}^{*} \} )}{ε ( \{ 1 \} )} . \qquad ( 2 )$$

The relative attenuation β*({α*}) is a vector of losses per energy component that varies dynamically, 0≤β*≤1. Referring to the base wave solver energy values from prior section with portals open and shut result in:

$${E}^{*} ( \{ {α}^{*} \} ) = {E}_{closed}^{*} + ( {E}_{open}^{*} - {E}_{closed}^{*} ) \times {β}^{*} ( \{ {α}^{*} \} ) .$$

The first term on right hand side,

$${E}_{closed}^{*} ,$$

is energy that bypasses all portals to arrive from source to listener. The second term takes the difference

$$( {E}_{open}^{*} - {E}_{closed}^{*} )$$

to calculate the energy that must thus have gone through the portal network. The last factor attenuates this energy based on the portal solver's estimation of the relative attenuation. Abbreviating to β*, the above can be re-arranged to the following form:

$${E}^{*} = {β}^{*} \times {E}_{open}^{*} + ( 1 - {β}^{*} ) \times {E}_{closed}^{*} . \qquad ( 3 )$$

This is a linear interpolation with weight β*, to compute dynamic energy E*. This is employed as an approximation to what the ground-truth base solver would produce with the current state of portal transmission losses. The portal solver dynamically drives the interpolation for any energy vector component (e.g., initial or reverb energy) computed by the ground truth wave solver, between the two extremes of all portals closed and all portals open. The output matches the accurate base solver's predictions at the two extremes of all portals open and shut, which provides robustness of this algorithm in complex scenes. To implement the system as a “plug-in” modification to the base system, the following form can be employed:

$$\begin{matrix}{E}^{*} ( \{ {α}^{*} \} ) = {E}_{open}^{*} {w}^{*} ( \{ {α}^{*} \} ) , \\ {w}^{*} ( \{ {α}^{*} \} ) ≡ {β}^{*} ( \{ {α}^{*} \} ) + ( 1 - {β}^{*} ( \{ {α}^{*} \} ) ) \times {S}^{*}\end{matrix} \qquad ( 4 )$$

$${E}_{open}^{*}$$

is the base system's output at runtime. w*({α*}) is the overall dynamic attenuation from the portal network. S* is the static energy fraction as described above. As a possible optimization (but not an algorithmic limitation), the static energy fraction field can be computed only for the initial energy and employed other energy components,

$${S}^{*} ( {x}^{′} ) ← S ( {x}^{′} ) , where S ( x ) ≡ {S}^{d} ( {x}^{′} ) , \qquad ( 5 )$$

denoted below as S(x′), dropping the super-script. This still retains plausible rendering while obtaining the following benefits:
1. Memory. An acoustic parameter field can be stored for each energy component S*(x′) for runtime evaluation of (4). Storing only a single S(x′) is cheaper on disk storage and runtime RAM.
2. Bake time. Restricting to initial energy reduces computation for the closed-portal solver that computes S^{d}. Resolving the first wavefront (shortest path) for every x′ is usually cheaper than computing the full reverberant field whether using a wave-based or geometric solver.
   With this further approximation, the following equation can be employed at runtime:

$$\begin{matrix}{E}^{*} ( \{ {α}^{*} \} ) = {E}_{open}^{*} {w}^{*} ( \{ {α}^{*} \} ) , \\ {w}^{*} ( \{ {α}^{*} \} ) = {β}^{*} ( \{ {α}^{*} \} ) + ( 1 - {β}^{*} ( \{ {α}^{*} \} ) ) \times S\end{matrix} \qquad ( 6 )$$

Loss Tuple. The following describes how the portal solver uses pre-computation to quickly compute β*({α*}) on the fly. The loss tuple is a general concept used throughout the system in how propagation loss is numerically characterized. An acoustic path that connects an emitter and listener in space via many portals can include many sub-paths between pairs of portals. The following describes an approach to characterize the propagation loss on each sub-path by composing the propagation losses to yield the net energy propagated from emitter to listener.

The present concepts can characterize propagation on each sub-path with a loss tuple: w=(g, [symbol] ) where g is the geodesic propagation distance of the sub-path, and [symbol] is the diffraction loss. The latter is fixed such that the sub-path's energy is:

$$E ( w ) = \frac{ℒ}{{g}^{2}} , where w ≡ ( g , ℒ ) \qquad ( 7 )$$

Under free field conditions only the inverse-square law is active, so that [symbol] =1 and E(w)=1/g². In the presence of geometry, the diffraction loss factor reduces, 0≤ [symbol] ≤1, factoring the additional losses introduced by the presence of geometry. Note that geodesic distance is employed, rather than line-of-sight distance in the denominator which ensures robustness in complex scenes where the sub-paths can have significant detour around static geometry.

Loss tuple: product rule. Consider a path composed of two sub-paths in series, each with corresponding loss: w₀={g₀, [symbol] ₀} and w₁={g₁, [symbol] ₁}. The loss product can be defined as:

$${w}_{0} \cdot {w}_{1} ≡ \{ {g}_{0} + {g}_{1} , {ℒ}_{0} \cdot {ℒ}_{1} \} \qquad ( 8 )$$

That is, geodesic distances add along sub-paths to capture the net inverse-square loss from wavefront expansion, while diffraction losses related to path bending around obstructions or going through portals multiply. This is motivated from both empirical observations and theoretical analysis of aperture diffraction as discussed shortly. The net energy of the path can then be computed from (7), yielding for this case:

$$E ( {w}_{0} \cdot {w}_{1} ) = {ℒ}_{0} \cdot {ℒ}_{1} / {( {g}_{0} + {g}_{1} )}^{2} .$$

The identity loss tuple is:

$${w}_{e} ≡ \{ 0 , 1 \} , so that w \cdot {w}_{e} = w . \qquad ( 9 )$$

And infinite loss is:

$${w}_{∞} ≡ \{ ∞ , 0 \} , so that w \cdot {w}_{∞} = {w}_{∞} . \qquad ( 10 )$$

Note that that the product is associative, commutative, and has an inverse:

$$\begin{matrix}{w}_{0} \cdot ( {w}_{1} \cdot {w}_{2} ) = ( {w}_{0} \cdot {w}_{1} ) \cdot {w}_{2} , \\ {w}_{0} \cdot {w}_{1} = {w}_{1} \cdot {w}_{0} \\ {w}^{- 1} ≡ \{ - g , \frac{1}{ℒ} \} .\end{matrix} \qquad ( 11 )$$

Formally, the tuples and product together form an abelian group. The main practical outcome is that due to associativity, a path has unique energy no matter how it is divided into sub-paths. This is consistent with physics since the net energy of a path should not change depending on the details of the accounting. Further, commutativity means that reversing a path has the same energy, obeying acoustic reciprocity.

With the above, the unique energy of a path with losses wₖ, k∈[0, nₖ) is:

$$E ( {w}_{0} \cdot {w}_{1} \cdot … \cdot {w}_{{n}_{k} - 1} ) = \frac{{\prod }_{k} {ℒ}_{k}}{{( {\sum }_{k} {g}_{k} )}^{2}} . \qquad ( 12 )$$

One data structure employed by the portal solver is a portal graph which has portal faces as vertices and these loss tuples edge weights representing propagation between ordered pairs of portal faces. Salient paths in the portal graph are constructed and stored. The portal solver at runtime then computes each path's net energy via multiple portals in series using the above formula. The energy across multiple alternative paths is summed to model global energy propagation via dynamic portals.

For each hop in the path, at runtime there will be a dynamic transmission loss αₖ. Since transmission loss is a multiplicative energy loss factor, it can be included in the diffraction loss using αₖ [symbol] ₖ in the numerator of (12), which upon refactoring yields: (Πₖαₖ)E(w₀·w₁· . . . wₙ_{ₖ}₋₁). This factorization allows pre-computing the second factor capturing path energies ignoring portal transmission losses. At runtime, only transmission losses along each path are computed dynamically to compute the first factor, saving significant runtime computation.

Motivation for tuple product rule. To motivate the product formula from (8), consider an approach that simply multiplies the energy along each sub-path. Then instead of (12), the result is

$${E}_{mult} = {\prod }_{k} {E}_{k} = {\prod }_{k} ( {ℒ}_{k} / {g}_{k}^{2} ) .$$

Consider a series of n−1 parallel infinite screens equidistant from each other at distance r₀. Now consider aligned circular apertures cut across their normal direction so there is line of sight from one side to another of the entire stack of screens. Consider propagation between a source and listener placed a distance of r₀ from the first and last aperture respectively, so that the straight line joining them passes through the center of all apertures, and the path has n hops of length r₀.

Now consider the large aperture limit, R→∞. The apertures should not matter, with the energy thus scaling as 1/(nr₀)²=1/(Σₖgₖ)² which is correctly predicted by (8). As noted below, as R→∞, [symbol] →1 with the aperture diffraction loss model. On the other hand, Eₘᵤₗₜ is highly inaccurate in this limit, instead yielding

$${E}_{mult} = 1 / {r}_{0}^{2 n} = 1 / ( {\prod }_{k} {g}_{k}^{2} ) .$$

However, from Huygen's principle, Eₘᵤₗₜ is accurate in the opposite limit of R→0, so that each portal is a sub-wavelength sized pinhole.

The tuple loss model from (8) in combination with determining the diffraction loss [symbol] using the aperture diffraction model reconciles these extremes as discussed in above, allowing multi-portal propagation modeling on a physically well-motivated footing.

Detour diffraction loss heuristics. Some implementations employ diffraction loss approximations that involve only the Euclidean (line-of-sight) distance, d and the geodesic (shortest-path) distance, g between two points as input. Two models can be employed, a half screen model and a disk model.

Half screen model. This model assumes two points placed symmetrically at distance d/2 to an infinite half-screen so that the line joining them is perpendicular to the screen's plane. The geodesic distance g>d is assumed to result from the half-screen intruding perpendicularly across the line joining the two points. The theoretical diffraction loss curves have a dependence on d as well and not just the detour, δ≡g−d. The dashed line above simplifies further to only take dependence on δ:

$${ℒ}_{half} ( d , g , k ) = \frac{1}{1 + 3 δ \frac{k}{2 π}} . \qquad ( 13 )$$

Note that from the definition of diffraction loss, geodesic distance attenuation is factored out, so that the acoustic energy is: [symbol] _{half}/g². This model is appropriate when the occlude is expected to be a wall section or building corner much larger than wavelength. The large size of the assumed occluder results in the sharp decrease in loudness as detour increases from 0 to 5 wavelengths and relatively weaker decrease thereon.

Disk model. This model fits the envelope of frequency-dependent diffraction loss computed with Kirchoff diffraction theory for two points placed symmetrically on the axis of a disk that occludes at distances d/2 on either side. With this geometry, the radius of the disk is R=0.5\sqrt{g²−d²} by Pythagoras theorem.

An excellent fit is found with the simple formula:

$${ℒ}_{disk} ( d , g ) = {( \frac{d}{g} )}^{2} . \qquad ( 14 )$$

The model predicts significantly less diffraction loss for the same detour, because it assumes a finite obstructing geometry that blocks a smaller portion of the incoming wavefront's area compared to the half-screen. This model is thus more appropriate when the size of occluder(s) that caused the detour is not known.

Some implementations use the disk model by default in the system, and the half-screen model only in aperture diffraction calculations because in the latter case it is reasonable to assume that the portal lies within a larger wall section that is well-represented by a half screen. Using the half-screen model for small occluders can cause unrealistically high loss for small detours due to its sharp negative slope for small detours.

Real-time aperture diffraction model. To enable real-time computation, assume a simplified circular aperture geometry in an otherwise infinite screen as a proxy geometry for actual portal geometries in the game world, since it is a reasonable proxy for typical aperture, the circular symmetry makes it amenable to analytical diffraction theory and consequently the disclosed runtime evaluation method.

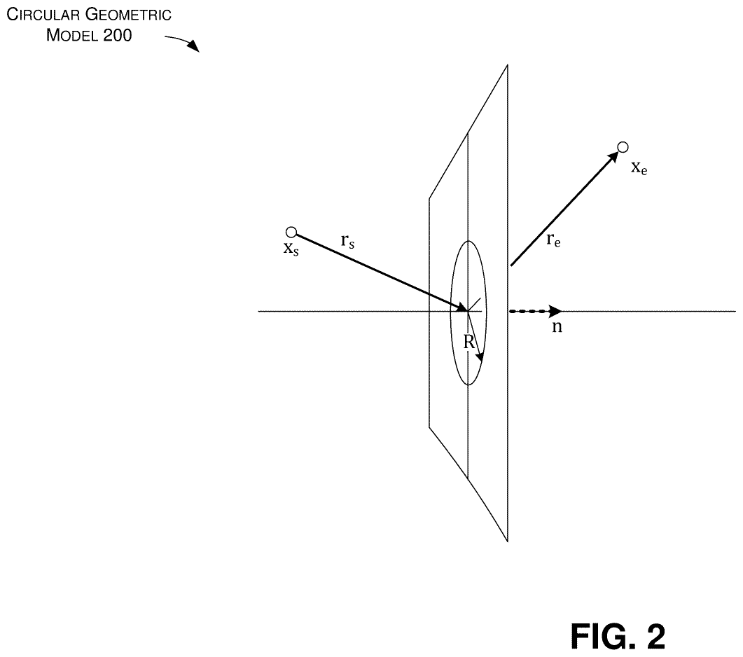

FIG. 2 shows a circular geometric model 200. This provides a geometrical setup for aperture diffraction. An infinite screen is shown in side-view with an aperture in the shape of a circular disk with radius R and oriented normal η.) There is a circular disk aperture in an infinitely thin but acoustically opaque screen with radius R whose center is at the origin, with a start and end point on either side of it at locations {xₛ,xₑ} respectively. The oriented normal of the aperture is η. The goal is to compute the diffraction loss factor, [symbol] , for propagation from the start to end point.

Even this geometrically simple case can be quite complex to compute accurately and in real-time. Fresnel and Fraunhoffer diffraction are two approximations in the near-field and far-field limit respectively that work well for various practical optical systems. However, the present concepts consider scenarios where a point can be in the extreme near-field of an aperture—such as when a player walks through a portal into another room, while the other point could also be near or far.

Thus, the present concepts provide a physically-based model that is approximate but fast to evaluate and produces plausible sound renderings. Consider a product model with three components, respectively the distance, angle, and turning losses:

$${ℒ}^{aper} ( {x}_{s} , {x}_{e} ; k , R , η ) = {ℒ}_{dist} \times {ℒ}_{angle} \times {ℒ}_{turn} . \qquad ( 15 )$$

Each of these losses is described in turn. Define the distances to aperture center: rₛ=|xₛ|, rₑ=|xₑ|, and smaller of the two: rₘᵢₙ=min(rₛ,rₑ).

Distance loss. Consider the case that xₛ=−ηr, xₑ=ηr. That is, at equal distance r on the aperture axis. An aperture that projects a large angle at either point (R>>r), can be expected to allow waves to pass through unimpeded as if not present, while a pinhole (R<<r) such as a small crack in a wall, acts as a secondary point source with diffraction loss expected to scale as

$$\frac{1}{{r}^{2}} .$$

For this restricted geometrical case, the Kirchoff diffraction approximation to the wave equation admits analytical solution, yielding:

$$\begin{matrix}{ℒ}_{dist}^{′} = \frac{{( kR )}^{2}}{2} \frac{1 + 2 {( \frac{r}{R} )}^{2}}{{( 1 + {( \frac{r}{R} )}^{2} )}^{2}} , \\ {ℒ}_{dist}^{′} ← min ( {ℒ}_{dist}^{′} , 1 ) .\end{matrix} \qquad ( 16 )$$

The clamp to 1 is because the axisymmetric case considered results in perfect constructive interference along the axis forming a caustic (Arago spot), and the present concepts can consider only when attenuation occurs and not when the amplification due to the caustic occurs.

The formula models the two key effects described previously in the

$$\frac{r}{R} ≪ 1 and \frac{r}{R} ≫ 1$$

cases. Considering the latter “pinhole” case so that R→0 with r held fixed, obtain:

$${ℒ}_{dist}^{′} \to {( kR )}^{2} {( \frac{R}{r} )}^{2} = Θ ( \frac{1}{{r}^{2}} ) .$$

Recall that this diffraction loss multiplies the geodesic distance attenuation of 1/(2r)² per the tuple loss model (7) to yield total energy that scales as

$$Θ ( \frac{1}{{r}^{4}} ) .$$

On the other extreme of

$$r ≪ R , {ℒ}_{dist}^{′} \to \frac{{( kR )}^{2}}{2} ,$$

so the diffraction loss scales as the area of the aperture measured in units of wavelength, but loses its dependence on r, so that energy scales as

$$Θ ( \frac{1}{{r}^{2}} ) .$$

This allows for predicting both extremes of energy loss for large and small aperture radius, R.

For the aperture problem at hand, consider two distinct distances, rₛ and rₑ. To enforce reciprocity and ensure that if either point is very close to the portal, the overall diffraction loss approaches 1, then simply use the smaller distance of the two. This is just a practical expedient that underestimates diffraction loss because the analytical formula at hand from above only applies to a much simpler case.

$${ℒ}_{dist} ( {x}_{s} , {x}_{e} , k ) ≡ {ℒ}_{dist}^{′} ( {r}_{min} , k ) . \qquad ( 17 )$$

Angular loss. For a source point far away from an aperture, if an arrival is from a glancing angle, the effective energy through the portal will reduce due to the smaller projected solid angle. However, as either point gets close to the aperture, the loss should gradually approach 1 until one of the points is on the portal in which case it can become 1 for a smooth rendering.

Assume a symmetric setup so that emitter and receiver points are mirrored with respect to the aperture's plane, both at distance r from aperture center, forming angle with aperture axis of

$$θ : cos θ = max ( 0 , η \cdot \frac{x}{r} ) .$$

Let g_{angle} be the geodesic distance between them via aperture.

The present concepts can use a low-frequency limit of the Kirchoff approximation that drops phase, to enable simple computation and compact tabulation. The integral is performed by ranging over the aperture in polar coordinates. The distance of either point, r, can be re-parameterized as:

$$Ω ( r ) ≡ atan ( \frac{R}{r} ) .$$

This maps the unbounded distance range to a finite one,

$$r : [ 0 , ∞ ] \to Ω : [ \frac{π}{2} , 0 ] ,$$

enabling tabulation. Then, multiply the energy estimate from the integral by the geodesic distance squared to compute the diffraction loss. Yielding:

$$G ( Ω , cos θ ) = {g}_{angle}^{2} \times \frac{2}{π} {{\int }^{Ω}}_{ω = 0} {{\int }^{2 π}}_{ϕ = 0} \frac{- {cos}^{2} θ sin ω d ω d ϕ}{{( 1 - sin 2 ω sin θ cos ϕ )}^{3 / 2} {( 1 + {α}^{2} {tan}^{2} ω - 2 α tan ω sin θ cos ϕ )}^{3 / 2}} \qquad ( 18 )$$

The function G can be tabulated via numerical integration. The lack of phase makes the integrand non-oscillatory, easing convergence in practice, with smooth variation for various inputs. The result is tabulated for Ω∈[0.01, atan(10)] with 50 uniformly spaced samples,

$$cos θ ∈ [ cos \frac{75}{180} π , 1 ]$$

with 20 samples. The range for Ω is set based on observing where the curve values flatten out for all θ. The lower limit for θ at 75 degrees is used because the Kirchoff approximation allows the acoustic energy to go to zero at glancing incidence when that does not happen physically. Even at perfectly glancing incidence, waves will diffract through an aperture. The result is a small table with 1000 floating point values. To evaluate, a bilinearly-interpolated lookup is performed, with input outside range clamped to the table's limits.

It can be shown analytically that the on-axis result for G matches the distance loss [symbol] from previous section for a wavenumber k₀ such that (k₀R)²=2. Some implementations can normalize out the on-axis loss because that is captured more precisely by [symbol] (including wavelength dependence which current model lacks), yielding,

$${ℒ}_{angle}^{′} ( r , cos θ ) ≡ \frac{G ( Ω ( r ) , cos θ )}{{ℒ}_{dist}^{′} ( r , {k}_{0} )} , {k}_{0} = \frac{\sqrt{2}}{R} , \qquad ( 19 )$$

$${ℒ}_{angle}^{′} ( r , cos θ ) ← min ( {ℒ}_{angle}^{′} ( r , cos θ ) , 1 ) .$$

This yields a diffraction loss interpretable as only due to angled incidence, with normal propagation loss captured by

[symbol]

To reduce table size, symmetric points are assumed above, but input points will be asymmetric in general. To ensure acoustic reciprocity, compute the halfway unit vector:

$$h = \frac{( {x}_{s} + {x}_{e} )}{\vert {x}_{s} + {x}_{e} \vert} ,$$

and then define: cos θₕ=max(h·η, 0). Compute the net angular loss,

$${ℒ}_{angle} ( {x}_{s} , {x}_{e} ) ≡ {ℒ}_{angle}^{′} ( cos {θ}_{h} , {r}_{min} ) . \qquad ( 20 )$$

Turning loss. Additional diffraction loss results when a wavefront bends around the portal, increasing with the degree of turning. To model this loss factor, use the half-screen diffraction model (13). Denote with x_{g}, the “geodesic point” on the aperture such that xₛ→x_{g}→xₑ is the shortest path from the start to end point via the aperture. Then compute,

$${ℒ}_{turn} ( {x}_{s} , {x}_{e} , k ) ≡ {ℒ}_{half} ( {d}_{se} , {g}_{se} , k ) , \qquad ( 21 )$$

$${d}_{se} ≡ \vert {x}_{s} - {x}_{e} \vert ,$$

$${g}_{se} ≡ \vert {x}_{s} - {x}_{g} \vert + \vert {x}_{e} - {x}_{g} \vert ,$$

where the two arguments are the line-of-sight and geodesic distances respectively for this case.

One-sided diffraction loss. When pre-computing salient paths in the portal graph, consider the concept of a “one-sided” diffraction loss that only requires a single point in relation to the aperture. This amounts to asking for an approximate product decomposition of the diffraction loss: [symbol] (xₛ,xₑ,k)≈ [symbol] (xₛ,k) [symbol] (xₑ,k), where [symbol] is a one-sided diffraction loss model.

To enable this, observe that the distance (16) and angular loss (19) factors above are already based on assuming a set of symmetric points on either side of an aperture. Turning loss (21) can be ignored since it fundamentally requires both locations, yielding:

$${ℒ}_{aper}^{o} ( x , k ) ≡ \sqrt{{ℒ}_{dist}^{′} ( r , k ) {ℒ}_{angle}^{′} ( r , cos θ )} , r = \vert x \vert , cos θ = η \cdot \frac{x}{r} . \qquad ( 22 )$$

the square-root ensures that if the two points are indeed symmetrically located with respect to aperture, the correct distance and angle diffraction losses (sans turning loss) can be recovered.

Portal graph. One data structure employed by the portal solver is the portal graph. First, a complete graph G is constructed. The complete graph G can model arbitrary propagation via any number of faces. The complete graph G can be reduced to a runtime graph G′ that models a strict subset of propagation paths from G. G′ is stored efficiently during baking and is employed at runtime by the portal solver.

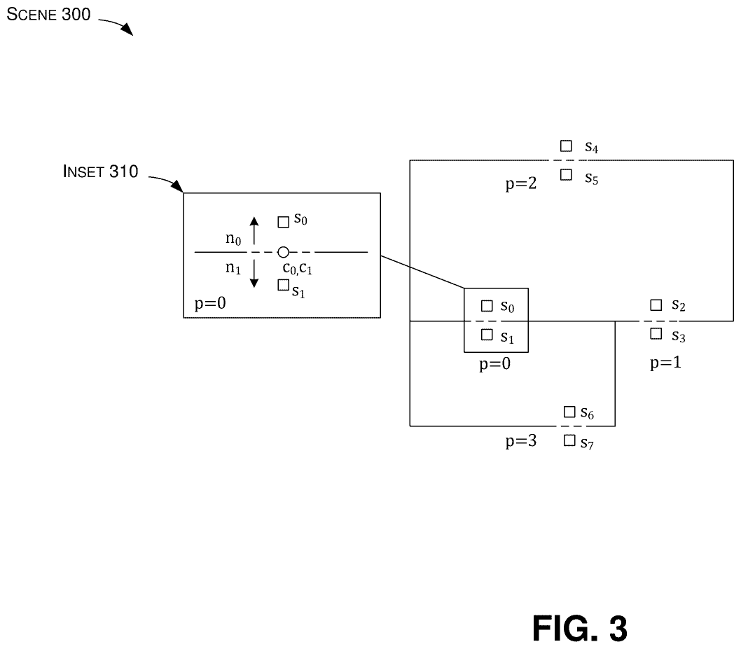

FIG. 3 illustrates the formalism with a scene 300 having nₚ=4 portals. Dashed lines in FIG. 3 show dynamic portals, indexed by p. Inset 310 shows corresponding seed cells, normals, and centers for the two faces of portal index p=0.)

Portals, p. Suppose there are nₚ portals within the simulation volume V for a probe. The portals can be indexed contiguously from 0 to nₚ−1. That is, p∈[0,nₚ).

Geometry, Gₚ. Each portal can be represented with an approximately planar 2D surface geometry, Gₚ, such that the entire opening of the portal is covered. For instance, this could be a triangular surface. This portal geometry could be specified manually or extracted automatically. In some implementations, the creator of a given scene can mark up the portals with data identifying their location, size, etc.

Normal, nₚ. The average normal unit vector for Gₚ is computed as nₚ, which points through the opening. Picking nₚ or −nₚ is arbitrary, not affecting system functionality.

Centroid, cₚ. The centroid of each portal geometry is also computed, denoted cₚ.

Portal faces, f. Since Gₚ is a surface, each portal's opening has two faces. Faces can be indexed by f∈[0, 2nₚ), with f={2p, 2p+1} being the front and back face of portal p respectively. By convention, the front face is the one in the direction of the portal normal, nₚ.
Denote with p_{f} the portal index for a given face f. The mapping

$$is : {p}_{f} ≡ ⌊ \frac{f}{2} ⌋ .$$

Denote with c_{f}≡cₚ_{_{f}} the centroid of the portal that possesses face f.
Denote with η_{f} the oriented normal of face f. Defined as η_{f}≡nₚ_{_{f}} if f is even (front face), and η_{f}≡−nₚ_{_{f}} if f is odd (back face).
Use f′ to denote the flip of face f, so that f and f′ are opposite faces of portal p_{f}. The explicit mapping is: f′≡f+1 if f is even, and f′≡f−1 if f is odd.
   Note that c_{f}=c_{f′} and η_{f}=η_{f′}.

Seeds, s_{f}. For each face, a seed location (or “seed” in short) can be employed for simulation, denoted s_{f}. The location is such that (s_{f}−c_{f})·η_{f}>0 while minimizing |s_{f}−c_{f}|. That is, the seed location is in front of the face per its oriented normal, as close as possible to its center. This is done while ensuring that the propagation solver allows placing a sound source at s_{f} when the geometry Gₚ_{_{f}} is included in simulation, thus blocking off the portal opening. For instance, for a grid-based wave solver, this could be the nearest non-solid grid cell to c_{f} in direction η_{f}.

Portal disks, D_{f}. The portal solver can utilize real-time diffraction calculation from the portal geometry, Gₚ. Diffraction from arbitrary-shaped apertures can be quite expensive. An approximate aperture diffraction formulation can be employed by fitting a proxy disk model denoted D_{f}={c_{f},R_{f},η_{f}} to Gₚ_{_{f}}. The normal and centroid can be taken as-is from the corresponding face. The radius R_{f} is fixed so that the disk's area

$$( π {R}_{f}^{2} )$$

equals the surface area of Gₚ_{_{f}}. With this the disks {D_{f}, D_{f′}} on opposite faces of a portal are identical except for opposing normal that point away from the portal on either side.

The choice of matching area is based on noticing the dependence on aperture area in (16) via the first factor of (kR)² which models the wavelength-dependent reduction in energy transmitted through a portal as a function of its area.

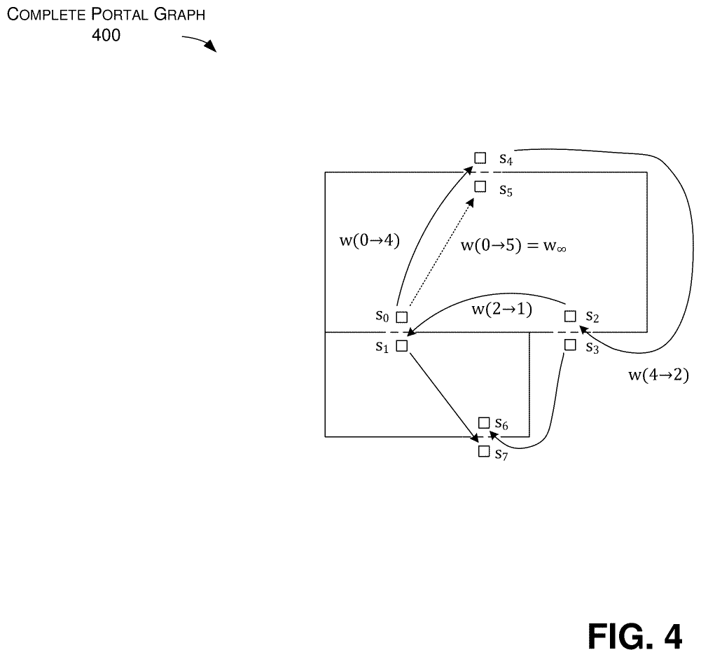

Complete portal graph, G(V,W). FIG. 4 shows a complete portal graph 400. The graph is complete, with edges between all pairs of faces. Note that while the graph itself can be complete, not all edges are shown in FIG. 4. Edge w(0→4) can have high energy E(w(0→4)), modeling sound radiating from face f=0 to exit through face f=4. Edge w(4→2) models propagation from face 4 that rounds the room outside, potentially interacts with geometry outside to incur additional loss, and radiates back inside through face 2. Edge w(2→1) models radiation from face 2 that exits through face 1. In this case, while the geodesic distance g(2→1) will be small, due to the small mutually projected area, the diffraction loss L(2→1) will also be quite small leading to an overall small energy E(w(2→1)). Finally, the edge w(0→5) will have infinite weight (E(w(0→5))=0) because there is no physical path that radiates from face 0, propagates without going through any other portals to eventually radiate from face 5 after piercing the corresponding portal. Such a path is impossible since this example both rooms are watertight once all the portal geometries are blocked off.

The complete portal graph is denoted G( [symbol] , W). Its vertices are portal faces, [symbol] ={f}, f∈[0,2nₚ). The graph is complete, with directed, weighted edges between all pairs of faces: W={w(f₁→f₂)}∀f₁, ∀f₂. Each weight w(f₁→f₂) represents energy propagation from face f₁ to f₂. The graph is not symmetric, so that in general w(f₁→f₂)≠w(f₂→f₁). The weight is a loss tuple pairing the geodesic distance and diffraction loss,

$$w ( {f}_{1} \to {f}_{2} ) ≡ \{ g ( {f}_{1} \to {f}_{2} ) , ℒ ( {f}_{1} \to {f}_{2} ) \} . \qquad ( 23 )$$

Edge Conventions and propagation topology. The following stipulations are sufficient to attach unambiguous physical meaning to propagation paths in the graph.
w(f₁→f₂) does not include contributions for propagation through any other portal. This ensures that physical propagation through multiple portals corresponds one-to-one with traversing edges within the graph. Note that the propagation f₁→f₂ may still include complex propagation effects from static intervening geometry within the world, which will contribute to the loss tuple on the corresponding edge as discussed shortly.
w(f₁→f₂) represents energy that radiates from f₁ and pierces portal p_{f}_{₂} to re-radiate from f₂. This convention ensures that when composing loss tuples w(f₁→f₂)·w(f₂→f₃), losses that occur at the portal due to aperture diffraction or dynamic transmission loss are not double counted.

As noted earlier, the adjacency matrix for the graph is not necessarily symmetric, because in general w(f₁→f₂)≠w(f₂→f₁) as they can correspond to distinct propagation paths per above conventions. In fact, together the two edges w(f₁→f₂) and w(f₂→f₁) form a physical propagation cycle of f₁ radiating into f₂ whose energy then propagates globally to radiate again through f₁: f₁→f₂→f₁. As a corollary, the self-edge w(f→f) corresponds to sound emitted by a portal face that re-radiates from it after circulating through the scene without going through any other portals. Acoustic reciprocity is still captured in the graph, just not as this simple symmetry, as discussed below.

Computing edge weights. The above constraints can be achieved by closing all portals, and running acoustic simulations over the simulation volume, V(x′), with each seed cell in turn as an acoustic point source proxy for its corresponding face. This takes a total of 2nₚ simulations to find all the weights in the graph. Since scenes can contain numerous portals, with nₚ of the order of hundreds, it can be useful to keep the cost of these portal simulations low, even though offline.

As two examples, the base solver or the Fast Marching Method (FMM) can be employed to perform these simulations. FMM is fast and computes only the geodesic shortest path distance from a given source point to all unoccupied (air) voxels on a grid. A single simulation from seed cell s_{f}_{₁} yields a geodesic distance field [symbol] _{f}_{₁}(x′). In case there is no path from s_{f}_{₁} to x′, FMM sets [symbol] _{f}_{₁}(x′)=∞.

The set of 2nₚ FMM solution fields is used to evaluate the edge geodesic distances as

$$g ( {f}_{1} \to {f}_{2} ) = {𝒢}_{{f}_{1}} ( {s}_{{f}_{2}^{′}} ) , ∀ {f}_{1} , ∀ {f}_{2} . \qquad ( 24 )$$

Note that the seed cell used was for index

$${f}_{2}^{′} ,$$

not f₂. Since all portals are shut during simulation, to get the length of the path that pierces p_{f}_{₂} to reach s_{f}_{₂} the distance to the seed cell on the opposite side of face f₂ is employed as an approximation.

That leaves the diffraction-loss for each graph edge's weight tuple. It is computed as a product of two factors:

$$ℒ ( {f}_{1} \to {f}_{2} ) = {ℒ}_{S} ( {f}_{1} \to {f}_{2} ) {ℒ}_{A} ( {f}_{1} \to {f}_{2} ) , \qquad ( 25 )$$

where [symbol] _{S} is the static diffraction loss due to static geometry that the geodesic path must detour around and [symbol] _{A} is the aperture loss between f₁ and f₂.

Without knowledge of the kind of geometry that caused the static diffraction loss, some implementations remain conservative towards underestimating, employing the disk obstruction model (14):

$${ℒ}_{S} ( {f}_{1} \to {f}_{2} ) ≡ {ℒ}_{disk} ( \vert {s}_{{f}_{1}} - {s}_{{f}_{2}^{′}} \vert , g ( {f}_{1} \to {f}_{2} ) ) . \qquad ( 26 )$$

Some implementations also temporarily store [symbol] _{S}(f₁→f₂) for later reference during runtime graph construction. The second factor, [symbol] _{A}, is the aperture diffraction loss for propagation between the portals based on their relative pose. Some implementations employ the one-sided diffraction loss from (22).

$${ℒ}_{A} ( {f}_{1} \to {f}_{2} ) ≡ {ℒ}_{{f}_{1}}^{o} ( {c}_{{f}_{2}} - {c}_{{f}_{1}} , {k}_{ref} ) \times {ℒ}_{{f}_{2}^{′}}^{o} ( {c}_{{f}_{1}} - {c}_{{f}_{2}^{′}} , {k}_{ref} ) . \qquad ( 27 )$$

Recall that c_{f} is the center of each face's disk D_{f}. Subscripts on diffraction losses indicate that the corresponding aperture disk's normal and radius should be used in (22). The net aperture diffraction loss is a product of one-way losses.

Some implementations employ the reference wavenumber

$${k}_{ref} = \frac{2 π v}{c}$$

with frequency v=1 kHz and speed of sound c=340 m/s. This choice can work well for typical portals encountered in games, shooting for the middle of the audible pitch range. k_{ref} is a tunable constant for the system.

Consider two adjacent windows on a shared wall of a room and the graph edge connecting the outside of either window to the inside of the other. The static loss [symbol] _{S}≈1 because of direct line of sight between the windows. However, the aperture loss [symbol] _{A}≈0 because their mutual projected solid angle approaches zero and this will be captured in the one-sided loss. Without such aperture diffraction, highly circuitous paths may (erroneously) have little loss, resulting in an implausible rendering. For instance, consider now two people conversing inside the same room, both standing next to either window. With [symbol] _{A}=1, and [symbol] _{S}=1, there is little loss on the path going from the speaker to outside the room through one window, entering back through the other window to reach the listener. It will have almost equal loudness as the direct sound inside the room. Which means that when either window is closed, half the acoustic energy is removed, which is quite a drastic, immersion-breaking departure from reality. With aperture diffraction, [symbol] _{A}≈0 and the corresponding graph edge acquires a strong overall loss, restoring plausibility.

As a final note, throughout the system the true geodesically incident and radiant directions at portals can be ignored when computing aperture diffraction, instead opting for line-of-sight directions. The geodesic directions at the portal are highly sensitive to local geometry, and may tend to work well only in combination with an accurate model for static diffraction loss that can model the high diffraction loss expected from any local geometry that causes a sharp change in the propagation direction near the portal. Since the static diffraction model conservatively under-estimates [symbol] _{S}, a simple and transparent approximation for input directions that is robust to local geometry around portal can be employed in the disclosed aperture diffraction calculations.

Reciprocity in the graph. The graph captures acoustic reciprocity in the form:

$$w ( {f}_{1} \to {f}_{2} ) = w ( {f}_{2}^{′} \to {f}_{1}^{′} ) ,$$

recalling that the prime indicates index of face on the opposite side of portal. This is because in the limit the seed cells are infinitesimally close to the portal centers, s_{f}→c_{f}, the corresponding acoustic paths are physically reciprocal.

Numerical edge weights can also obey reciprocity in this form. The aperture diffraction loss from (27) transparently obeys reciprocity,

$${ℒ}_{A} ( {f}_{1} \to {f}_{2} ) = {ℒ}_{A} ( {f}_{2}^{′} \to {f}_{1}^{′} ) .$$

However, there is a small amount of numerical deviation between the reciprocal pairs

$$\begin{matrix}\{ ℊ ( {f}_{1} \to {f}_{2} ) , ℊ ( {f}_{2}^{′} \to \\ {f}_{1}^{′} ) \} and \{ {ℒ}_{S} ( {f}_{1} \to {f}_{2} ) , {ℒ}_{S} ( {f}_{2}^{′} \to {f}_{1}^{′} ) \}\end{matrix}$$

because the seed points are not in fact at portal centers. Error can be reduced and reciprocity enforced by setting:

$$\begin{matrix}{ℊ}_{↔} ≡ \frac{ℊ ( {f}_{1} \to {f}_{2} ) + ℊ ( {f}_{2}^{′} \to {f}_{1}^{′} )}{2} , \\ ℊ ( {f}_{1} \to {f}_{2} ) ← ℊ ( {f}_{2}^{′} \to {f}_{1}^{′} ) ← {ℊ}_{↔} \\ {ℒ}_{↔} ≡ \sqrt{ℒ ( {f}_{1} \to {f}_{2} ) ℒ ( {f}_{2}^{′} \to {f}_{1}^{′} )} , \\ ℒ ( {f}_{1} \to {f}_{2} ) ← ℒ ( {f}_{2}^{′} \to {f}_{1}^{′} ) ← {ℒ}_{↔}\end{matrix}$$

for each of the pairs {f₁,f₂}. Some implementations employ arithmetic mean for geodesic distances and geometric mean for diffraction losses, consistent with the loss tuple product rule (8).

Automatic encoding of scene topology. One concept represented by the graph is that if little energy can get from one face to another, the corresponding weight will smoothly tend to zero and will be precisely zero if they are mutually unreachable. So, the graph automatically extracts the discrete propagation topology in a scene if present, such as a building floorplan. This can occur without any room markup from user, or assumption of watertight rooms, or explicit graph built by user describing the scene topology.

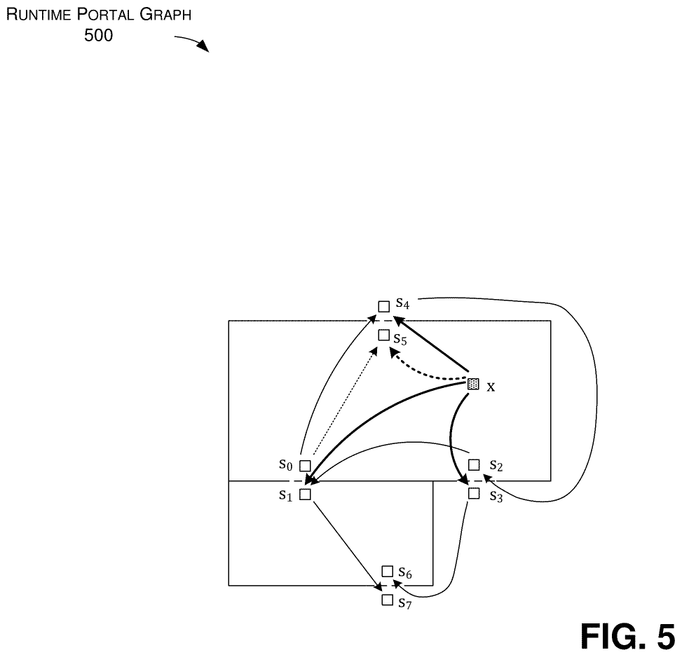

Runtime portal graph, G′. FIG. 5 shows a runtime portal graph 500. The runtime portal graph adds the probe (at location x) with an index fₓ=−1. New edges are added from fₓ to each reachable face, keeping only the more energetic edge per-portal. For instance, the edge fₓ→5 is discarded in favor of fₓ→4. This yields the set of “root” faces, {fᵣ}={1,3,4}, nᵣ=3 in this case. The resulting graph models reciprocal energy propagation: starting from the probe and piercing a unique portal in turn as edges are traversed.)

The runtime graph G′ can be initialized with G and then mutated by a series of steps described next.

Insert probe into graph. In principle, the graph G can be used to approximately compute the acoustics between any two points in the scene, as long as on the appropriate tuple losses weights (geodesic distance and diffraction loss) connecting either point to all faces in the graph can be evaluated. Then for any enumeration of paths through the graph connecting the two points, the per-path energy can be summed according to (12). It does not matter which point is source and which is listener since the graph fully obeys acoustic reciprocity.

This symmetry can be broken for computational benefit. While the emitter location x′ may only be known at runtime, the probe at x represents a listener location at runtime that will be interpolated to the continuous listener location. The probe can be added as a particular vertex in the graph, with weight denoted w(fₓ→f), with f ranging over all faces, where the index fₓ≡−1 is used to indicate the probe. Note that with this insertion, the graph now acquires a direction of energy flow that is reciprocally radiating outward from the probe, into the graph, and eventually to an emitter location at runtime. Some implementations attempt to maximize precomputation so that when the emitter location becomes known at runtime, less computation is required to complete the simulation and compute the total energy flow between probe and emitter.

The probe edge weight to every face can be found by running an additional FMM simulation from the probe's location, x, to obtain gₓ(s_{f′})∀f. The accurate closed-portal solution used in (1) can be re-used to get an accurate estimation of diffraction loss between probe and each portal face via:

$${ℒ}_{x} ( {s}_{{f}^{′}} ) ≡ min ( {E}_{closed}^{*} ( {s}_{{f}^{′}} ) {ℊ}_{x}^{2} ( {s}_{{f}^{′}} , 1 ) .$$

Then set,

$$w ( {f}_{x} \to f ) = \{ {ℊ}_{x} ( {s}_{{f}^{′}} ) , {ℒ}_{x} ( {s}_{{f}^{′}} ) \} ∀ f . \qquad ( 28 )$$

For faces unreachable from the probe, gₓ(s_{f′})=∞, and set w(fₓ→f)=w_{∞}.

Self-edge removal and root faces. Next, some implementation can begin trimming paths to reduce data and save CPU while retaining plausible quality.

Self-edges. First, self-edges in the graph are removed, setting w(f→f)=w_{∞} as these just represent long cycles via the scene.

Root faces. For each pair of opposite faces {f,f′}, consider the probe-edge energies computed from (7) {E(w(fₓ→f)),E(w(fₓ→f′))}. If both are finite, an infinite weight (w_{∞} from (10)) can be set for the edge with smaller energy, effectively removing it from the graph. The intuition is that if the probe happens to be inside a room, the chosen edges are the “natural” ones that correspond to reciprocal energy flowing from the probe to outside via the room's portals. The rejected edges correspond to circuitous paths where reciprocal energy radiates from probe, exits the room without going through any portal, and enters the room through a portal in the room. This chosen set of nᵣ faces with edges from the probe with finite weight are called “root faces” or “roots” for short, that will be denoted with {fᵣ}, r∈[0, nᵣ). Next, build a shortest-path tree from each root face (hence the name “root”), which is the runtime graph's representation. By removing probe edges as above, up to a factor of two on graph data size and runtime computation can be saved.

Compute shortest-path tree with modified Dijkstra. Next, construct nᵣ shortest path trees, by using Dijkstra's single-source shortest path algorithm, executing from each root face fᵣ in turn. The Dijkstra shortest path algorithm can be modified because the edge weights are tuples rather than scalar weights. Consequently, the algorithm does not necessarily guarantee global optimality like Dijkstra but nevertheless works sufficiently well.

The modification to Dijkstra is as follows. Rather than maintaining a scalar path weight to the root, instead maintain the cumulative tuple weight to root: [symbol] ={ [symbol] , [symbol] } for any active vertex f₁, initialized with wₑ≡{0,1} for the root face fᵣ and w_{∞}={∞,0} for all other vertices.

One step in Dijkstra is to compute and compare scalar path weights to root among multiple candidates and choosing the minimum. This step can be modified as follows. Given any candidate f₂ that has a finite weight w(f₁→f₂), first compute its net path weight to root as: [symbol] = [symbol] ·w(f₁→f₂), and then compare inverse energy: 1/E( [symbol] ), to find the minimum between candidates for f₂ to make the greedy choice. This amounts to choosing “shortest” path in the sense of “maximum energy to root.” Once the decision is done, store the path weight tuple [symbol] in vertex f₂, and assign f₁ as its parent to complete the iteration.

Dijkstra iteration can continue as usual from there to find the next best greedy choice until all vertices reachable from the root are exhausted. Once the shortest path tree has been computed, all path weights [symbol] fare thrown away. The one-sided diffraction loss model used during construction of G was an expedient to enable this graph shortest-path finding. Now that the paths are known, aperture diffraction loss can be precomputed more accurately.

Shortest-path tree. Building shortest-path trees aims to find a unique path connecting each root fᵣ to every face, discarding cyclical paths. The set of paths chosen this way is not necessarily the set of most energetic paths in the graph. Using a shortest-path tree provides several technical advantages, however.

Storage. Each tree captures O(nₚ) paths with O(nₚ) storage compared to storing a set of arbitrary paths which can cost

$$O ( {n}_{p}^{2} )$$

when done naively. Thus, compression is gained by restricting to shortest paths. The total storage scales as Θ(2nₚnᵣ). In contrast the graph G has

$$O ( 4 {n}_{p}^{2} )$$

information because it is complete. The cost automatically improves further to Θ(2nₚ) when nᵣ is close to 1, which happens when the probe is inside a watertight room.

Computation. At runtime, each path is consulted to accumulate its dynamic energy contribution. Since each vertex represents a unique path, computational cost scales same as storage above, with the portal solver touching each tree node a constant number of times. Thus, organizing the data into a tree via eliminating cycles means the computation is fast and one can limit it beforehand, rather than flowing energy through an arbitrary graph towards convergence. This is a relatively simple approach that bounds CPU cost, which can be important for real-time audio rendering in games.

Path Culling. As a follow-on to the last point, this data organization allows for culling of an individual “weak” path with the expedient of removing a corresponding vertex from one of the trees. Two controls are discussed later that work to simultaneously reduce storage and CPU cost while trading off rendering quality.

Computer path weights for runtime, G′. With knowledge of each complete path from the probe, via each root, up to any portal face in the scene, the full diffraction model can be applied at each portal. This can be performed once the paths are known because aperture diffraction loss is ternary: involving two points on either side of an aperture to compute diffraction loss.

By this point, the runtime graph G′ is a set of nᵣ disjoint trees with roots {fᵣ}, r∈[0,nᵣ). The processing described below applies to each tree Tᵣ independently. Since each vertex f,f∈[0,2nₚ) in the tree has a unique path to the root, which then implicitly connects to the probe, runtime computation can be saved by precomputing the net path loss tuple [symbol] (fₓ→f)≡{ [symbol] (fₓ→f), [symbol] (fₓ→f)} for the propagation path from the probe, via root face fᵣ, up to portal face f:x→fᵣ [symbol] f. Since all path energies will be from the probe fₓ implicitly, notation going forward is simplified to, [symbol] (f)≡{ [symbol] (f), [symbol] (f)}. The description below applies to each tree in sequence, so the subscript r is dropped when clear from context.

The following algorithm can be employed:

```
For each tree Tᵣ in turn:
For every face index, f ∈ [0,2nₚ), compute [symbol]   (f) as follows:
  If f is not part of the tree Tᵣ (has infinite weight), set [symbol]   (f) =
    w_{∞} and skip remaining steps to consider next face.
  Initialize path weight with first hop from probe to root: [symbol]
    (f) = w(fₓ → fᵣ).
  If f = fᵣ, done. Skip remaining steps to consider next face.
  List all faces on the unique path from the root face fᵣ to f.
    Let's say these are \tilde{f}ₖ, k ∈ [0,nₖ). Note that previous
    step guarantees nₖ > 1. The first face is \tilde{f}₀ = fᵣ, and
    last is \tilde{f}ₙ_{ₖ}₋₁ = f.
  Make two passes on the path. The first pass accumulates
    net diffraction loss along path into [symbol]   (f), and notes
    geodesic points on disk. Second pass uses the
    geodesic points to do a first-order correction for
    geodesic path length to “string tighten” it via the
    apertures.
```

First pass: diffraction loss. The first pass can accumulate the aperture diffraction loss from all apertures except from f, since the emitter location is unknown during baking. Latter is deferred to runtime computation. The following algorithm can be employed:

```
  For path indices k ∈ [0, nₖ − 1), do:
    1. Compute the aperture diffraction loss from (15) for
        $aperture disk {D}_{{f}_{k}} : {ℒ}_{{f}_{k}}^{a p e r} ( {c}_{{f}_{k - 1}} , {c}_{{f}_{k + 1}} ) . Compared to the$
        one-sided losses used during construction of G, this
        provides a more accurate diffraction loss for directed
        propagation between face centers on either side via
        face fₖ. For k = 0, set c_{f}_{_{−1}} ≡ x, since in that case the
        geometric path starts at the probe, goes via root face,
        on to c_{f}_{₁}.
    2. During aperture diffraction computation, obtain the
        geodesic point x_{g} on the aperture so that c_{f}_{_{k−1}} → x_{g} →
        c_{f}_{ₓ₊₁} is the geodesic path via aperture disk. Store
        location into a temporary list x_{g}(k) which is used in the
        second pass.
    3. Recall that the static diffraction loss [symbol] ₛ from (26) was
        stored separately, and can now be employed to
        compute and accumulate the overall diffraction loss
        for propagation between the portal faces as:
          $( f ) ← ( f ) \times ( ( {c}_{{f}_{k - 1}} , {c}_{{f}_{k + 1}} ) ( {f}_{k} \to {f}_{k + 1} ) ) .$
    4. Accumulate geodesic distance: [symbol]
(f) ← [symbol] (f) + g(fₖ → fₖ₊₁).
```

Second pass: geodesic distance correction. The geodesic path length computed above accumulates center-to-center geodesic distances between portals on the path, since that is how the FMM simulations were performed during the construction of G. With the topology of propagation path now known, the geodesic distance estimation can be improved, not forcing the physical path to go through aperture centers, which can introduce large errors when portal size is big. The following algorithm can be employed:

```
1. Use the geodesic points from above to compute an additive
      correction factor,
        $δ ( f ) = {\sum }_{k = 0}^{{n}_{k} - 1} \vert {x}_{g} ( k ) - {x}_{g} ( k - 1 ) \vert - \vert {c}_{{f}_{k}} - {c}_{{f}_{k - 1}} \vert .$
      Use x_{g}(nₖ − 1) = c_{f} since the geodesic point for the last
      face is unknown until runtime and is not set in the first pass.
      This last hop correction can be deferred to runtime. Further,
      assume c_{f}_{_{−1}} = x_{g}(−1) = x, since the path starts at the
      probe.
2. The path geodesic distance is then updated as: [symbol]
(f) ← max(0, [symbol] (f) + δ [symbol] (f)).
```

The above two passes may be seen as the first iteration of a relaxation procedure. Some implementations can take the geodesic points x_{g}(k) and re-run the two passes with the geodesic points as improved representatives of the true global shortest path. These implementations can continue iterating until convergence to obtain a geometrically optimal shortest path through multiple portals. A single pass is sufficient in practice, but doing more passes is not out of the question in future to improve accuracy for large portals. However, during precomputation the path is constrained to end at the center of the last face which is not correct. As described later, runtime processing can be employed to correct for this with knowledge of x′. Any additional relaxation passes would then be best performed at runtime after this correction, which will cost significant CPU without the benefit of precomputation as above.

With above algorithm, nᵣ trees are obtained, with weights [symbol] (f) where each face f has a weight containing the geodesic distance and diffraction loss for reciprocal propagation from probe, via fᵣ, up to the face. This set of nᵣ disjoint trees is the runtime graph G′ that is stored to disk.

The missing precomputed information in G′ is the aperture diffraction loss and geodesic correction for last hop via face f to x′, which can be performed at runtime. In this sense, G′ is maximally precomputed, minimizing the graph compute performed at runtime. In some cases, this can also account for geodesic detour and static diffraction loss from intervening static geometry for f→x′ but this can be ignored to save on data, as discussed next.

Face cluster. Reciprocally to how the probe has weights to a set of root faces, the emitter at runtime can also employ edge weights to a set of “emitter faces” that have a high-energy path to the emitter location. However, unlike the probe which has a fixed location known at bake time, the emitter location x′ can range over the simulation volume V, with precise location unknown at bake time.

Motivation. To support any x′, one simple but expensive option is to store for runtime use the geodesic distance fields { [symbol] _{f}(x′)}, for all faces that have been precomputed. From the geodesic field, the tuple weight w(f→x′) can be computed on the fly, and then [symbol] (f)·w(f→x′) can be composed long with aperture diffraction and geodesic correction. This would make the whole algorithm reciprocally consistent with probe and emitter treated the same (apart from the usage of accurate base solver for diffraction loss from probe to each root).

However, this would involve storing 2nₚ additional fields { [symbol] _{f}(x′)} alongside the base system's other baked information. A reasonable value for nₚ=100 in practice, and several hundred additional fields is an enormous amount of data practically. One possible approach for reduction is to store the M=2 to 4 (say) largest energy-contributing emitter faces for each x′. However, this would also involve storing the corresponding face index, which still leads to between 4 and 8 additional fields, which is still quite significant. In addition, this can introduce jumps in the loudness rendered any time the listener is in a room with M+1 portals such that all are nearly equidistant, with a dynamic sound source outside moving across the portals, which can happen frequently in video games.

Thus, some implementations can err on the side of ensuring smooth results with relatively little additional storage. Assume that every face that is reachable from any emitter location x′, with all portals shut, is included in the set of emitter faces used for x′. The advantage is that reachability is transitive: mutually reachable faces thus form a disjoint partition of the set of all faces {f}, which are referred to as (emitter) face clusters. With reachability as a binary proxy for complex propagation, an approximation is that when computing losses at runtime, assume that g(fₑ→x′)=|s_{f}_{ₑ}−x′|, [symbol] (fₑ→x′)=1 for any emitter face fₑ, thus ignoring any intervening static geometry.

Computing the face cluster, C and cluster index field, I(x′). The input is the set of geodesic fields { [symbol] _{f}(x′)} described above. Recall that if a point x′ is not reachable from face seed s_{f}, the FMM solver sets [symbol] _{f}(x′)=∞. The following algorithm can be employed:

```
Initialize an empty cluster list, C = { } and create a 3D cluster index
  field, I(x′),x′ ∈ V.
Repeat for all x′ by ranging over all the discrete cell centers in V:
  Assemble the set [symbol]   (x′) of faces reachable from x′: [symbol]   _{f}(x′) ≠
    ∞,∀f ∈ [symbol]   .
  If [symbol]   (x′) is empty, set I(x′) = −1 and skip over remaining
    steps.
  If [symbol]   (x′) ∉ C append it to C.
  Find the unique cluster index m so that C(m) = [symbol]   (x′). Set
    I(x′) = m.
```

The result is list of face clusters, C, and a single integer field I(x′) that contains indices into C. For any x′, [symbol] (x′)=C(I(x′)) yields the set of emitter faces fₑ∈ [symbol] (x′) that an emitter at x′ can reach and thus radiate into, with the convention that C(−1) returns the empty set.

The storage cost is primarily in the single integer field I(x′), which is tiny compared to storing 2nₚ geodesic fields discussed previously. Furthermore I(x′) is quite compressible, with a constant value for every contiguous volume of air in V.

Some implementations can sacrifice accuracy—“hard to reach” is not distinguished from “easy to reach” by this approximation, efficient as it might be. Also, the approximation on the emitter side no longer has reciprocal symmetry with the probe, which does store smooth weights to all root faces. This still works out in practice, presumably because in a game situation, the camera is usually at the player and it matters much more that the visible portals in the player's immediate vicinity behave correctly, compared to the emitter, which is usually in a different room to have portal occlusion applied, making the approximation less impactful. The present approximation nevertheless ensures that as source moves, the results change smoothly.

Runtime portal solver. As noted above, the portal solver's dynamic input at runtime is a vector of dynamic transmission losses via each portal face, provided as a list {α*(f)}, where the * ranges over energy components such as dry and reverb. Alongside, the listener and emitter locations {x,x′} are also passed along to the portal solver from the base system, from which it must compute the dynamic acoustic energy between source and listener ε*({α*}) and the portal-open energy ε*({1}). Their ratio is the loss factor β*({α*}) per (2) which is plugged into (6) to modify the base system's energy values with portals open. The following describes how to calculate the portal solver's output: β*({α*}).

A base system can apply spatial interpolation given continuous {x,x′} based on the sampled probe and emitter locations during precomputation. For the following, assume x is at a probe location, and x′ is a sampled location in the fields stored previously. For other continuous locations, the base system's spatial interpolation can be performed on the computed β* as well, in parallel to all other acoustic quantities, before the application of (6).

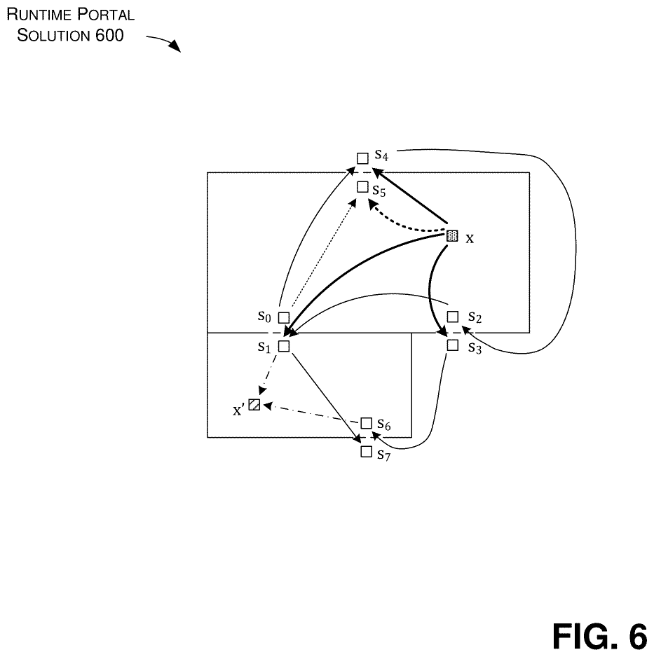

FIG. 6 illustrates an example runtime portal solution 600. The emitter position x′ is used to look up the corresponding set of “emitter faces,” fₑ={1,6} in this case. The precomputed root faces for the probe are fᵣ={1,3,4}. Using the runtime graph G′, the portal solver constructs all-pair shortest paths x→{fᵣ} [symbol] {fₑ}→x′. That yields 6 paths in this case. For each path, the portal solver computes the path weight correction for last-hop diffraction and geodesic correction at fₑ to compute the path's overall energy. The portal solver also collects each path's overall dynamic transmission loss. Accumulating over paths yields the energy without and with dynamic transmission losses, E* ({1}) and E* ({a*}) respectively. Their ratio β* is plugged into equation (6) to render the overall dynamic effect of the portal network on propagation between x and x′.)

Runtime Portal Solver Algorithm. At runtime, the portal solver can accumulate energy over all paths of the form: x→{fᵣ} [symbol] {fₑ}→x′, for the set of all root faces {fᵣ} and all emitter faces {fₑ}. The latter depends on emitter location. The squiggly arrow “ [symbol] ” indicates any number of intermediate faces on the unique shortest path between a pair of root and emitter faces stored in the runtime graph G′. Note the sets {fᵣ} and {fₑ} can overlap, so the summation is inclusive of paths of the form: x→fᵣ→x′. Such paths are highly salient, representing a sound outside a room heard by a listener inside via a room portal (or vice-versa).

As noted above, the runtime graph G′ is a set of nᵣ trees, where the weight at each portal face f, [symbol] (f) is the loss tuple for [symbol] reciprocal energy propagation from the probe up to f. So, for each path: a) complete the last hop in the path from fₑ→x′ accounting for any additional losses, and b) compute the dynamic transmission loss based on the sequence of faces on path.

The following algorithm can be employed:

```
  1. Consult the cluster list and cluster index field to find the set of
      emitter faces: {fₑ} = C(I(x′)) for the emitter. If {fₑ} is empty,
      the emitter cannot reach any portal. Set β* = 1 and skip
      remaining steps, since dynamic portals have no effect.
  2. Initialize [symbol] ({1}) = [symbol]   ({α*}) = 0.
  3. Denote with Pᵣ(f) the parent face of f in tree Tᵣ.
      For each tree Tᵣ, and for every emitter face {fₑ}, recursively
        evaluate the path transmission loss: [symbol] (f) = α*(f) × [symbol]
        (Pᵣ(f)). The recursion terminates at the root node
        for which [symbol] (fᵣ) ≡ α*(fᵣ).
      For each tree Tᵣ, the recursion can be evaluated in O(nₚ)
        operations across all faces as follows. Use
        memoization and store [symbol] (f) during the recursion
        within respective tree nodes. Terminate recursion
        when an already-store value is encountered instead of
        always going up to the root. Since each node is ever
        only updated once, and the size of the tree is |Tᵣ| ≤
        2nₚ, with linear complexity.
      The net complexity of this step is O(nᵣnₚ)
  4. The precomputed weight stored in tree [symbol] (fₑ) = { [symbol] (fₑ), [symbol] (fₑ)}
      includes propagation path loss from probe up to face fₑ,
      excluding the aperture diffraction loss for fₑ. Include this
      value now (at runtime) knowing the emitter location, x′.
      For each tree Tᵣ, and for each emitter face fₑ ∈ [symbol] , repeat the
        following.
        a. Compute the diffraction loss through face fₑ using
            $( 15 ) \text{:} {ℒ}_{r} ( {f}_{e} ) = {ℒ}_{{f}_{e}}^{aper} ( {c}_{{P}_{r} ( {f}_{e} )} , {x}^{′} ) , where {c}_{{P}_{r} ( {f}_{e} )} ≡ x$
            if f = fᵣ. There is no static diffraction loss
            component since there may be no information
            stored for the acoustic path fₑ → x′, as
            discussed above, so assume line-of-sight
            propagation.
        b. The previous step yields the geodesic point on
            aperture disk, x_{g}. Compute gᵣ(fₑ) = |x' − x_{g}| +
            δ_{g}, where δ_{g} = |c_{P}_{ᵣ}_{(f}_{ₑ}₎ − x_{g}| − |c_{P}_{ᵣ}_{(f}_{ₑ}₎ − c_{f}| · δ_{g}
            is an x′ -dependent correction for [symbol] (fₑ)
            changing propagation from c_{P}_{ᵣ}_{(f}_{ₑ}₎ → c_{f}_{ₑ} (that is,
            with path ending at center of face fₑ) as
            assumed during the construction of G′ during
            baking, to instead go via geodesic point:
            c_{P}_{ᵣ}_{(f}_{ₑ}₎ → x_{g} → x′.
        Note that the above exploits the structure of the
            product rule (8) to fold the “upstream” δ_{g}
            correction into gᵣ(fₑ) rather than modifying the
            graph weight [symbol] (fₑ). The latter cannot work
            because the correction δg is dependent on x′.
        c. Combining the stored path losses for (x [symbol]  fₑ) and
            the just computed loss for (fₑ → x′), and
            compute net path energy using (7), [symbol]
(fₑ) = E( [symbol]  · {gᵣ(fₑ), [symbol] (fₑ)}).
        d. Accumulate path contribution into total energy
            without and with dynamic losses respectively, [symbol]
({1}) ← [symbol] ({1}) + [symbol] (fₑ), [symbol]
({α*}) ← [symbol] ({α}}) + [symbol] (fₑ) [symbol] (fₑ)
        The net complexity of this step is Θ(nᵣ • |{fₑ}|) =
            O(nᵣnₚ).
  5. Compute β*({α*}) = [symbol] ({α*})/ [symbol] ({1}), and modify base solver’s
      output with (6).
```

Pre-culling weak paths from runtime portal graph, G′. The computational complexity of the above procedure is O(nᵣnₚ), linear in the total number of vertices across all trees in G′. The complexity automatically improves to O(nₚ) if either x or x′ happens to be in a watertight room with O(1) portals. To provide the user more fine-grained control to reduce CPU cost trading off quality, some implementations can trim the trees during baking based on specified thresholds.

Absolute energy threshold, ϵ_{abs}. For every tree Tᵣ, remove any vertex f such that,

$$E ( ( f ) ) < {ϵ}_{abs} .$$

The default value is ϵ_{abs}=10⁻⁸, corresponding to a path loudness of −80 dB. As a special case, if the face is a root, i.e., f=fᵣ, then the entire tree Tᵣ is removed from G′. This special case can be tested in advance when the roots are first identified to save precomputation. The idea is that if the propagated energy of a face up to the probe is already negligible, then even with a loud emitter at runtime right in front of that face so that w(f→x′)=wₑ, it will not propagate substantial enough energy to the listener and can be conservatively ignored without knowledge of runtime emitter location.

Relative energy threshold, ϵᵣₑₗ. In this culling pass is that the propagation is modeled in the form: x→{fᵣ} [symbol] {fₑ}→x′. The former is the set of all roots, and the latter is the set of emitter faces that only ever comes in known sets as well, namely the face clusters C. Without knowledge of x′ some implementations can still remove relatively weak paths in the set {fᵣ} [symbol] {fₑ}, that are deemed never to contribute “significantly” to the overall sum. Some implementations use a conservative default threshold of ϵᵣₑₗ=0.01, meaning paths carrying less than 1% energy in the sum are discarded during baking.

First pass: root faces. Consider all paths of the form: x→{fᵣ} [symbol] f→x′, consider each face f in turn. That is, from the probe, via all roots, up to face f. These paths can contribute together, with strongest contribution when an emitter is near f. Some implementations remove relatively weak paths. The following algorithm can be employed for the first pass:

```
  For every face index f,
    Compute the set of path energies to the probe across trees Tᵣ:
Eᵣ(f) = E( [symbol]  (f)), ∀r ∈ [0, nᵣ).
    Remove face f from tree Tᵣ if:
${E}_{r} ( f ) < {ϵ}_{rel} \cdot {max}_{r} \{ {E}_{r} ( f ) \} .$
```

Second pass: emitter faces. Consider all paths of the form: x→fᵣ [symbol] {fₑ}→x′, comparing across emitter faces within each face cluster in turn, since they always contribute together. The following algorithm can be employed for the second pass:

```
  For every tree Tᵣ in turn,
    For every face cluster {fₑ} ∈ C,
      Consider the set of path energies to the probe across
        the face set, {fₑ}:
                Eᵣ(fₑ) = E( [symbol]  (fₑ)), ∀ fₑ.
        Remove face index fₑ from tree Tᵣ, if,
                ${E}_{r} ( {f}_{e} ) < {ϵ}_{rel} \cdot {max}_{\{ {f}_{e} \}} \{ {E}_{r} ( {f}_{e} ) \} .$
```

This second pass is less conservative than the first one, because unlike the probe that is at one singular location, the emitter can range over a whole cluster: regions of space where {fₑ} is constant. A more precise test could involve moving the emitter over each such constant region, running the portal solver from each location, and only removing a face if its energy contribution is below threshold relative to all other faces in {fₑ}, for every point in the region. With the small default value of ϵᵣₑₗ, it is already a useful control for the end-user to introduce more approximation to gain CPU.

Baking algorithm summary. For each probe, compute and store the following additional data alongside base system's per-probe data.

```
Static energy field, S(x′). Optionally, this can be compressed well
  by mapping to loudness domain: 10 log₁₀ S(x′) , and
  quantizing with a resolution of 1dB when S ≈ 1.
List of portal disks, D_{f}
Portal graph, G′, with optional culling.
  Each tree Tᵣ may be packed compactly into an array
    representation indexed by f:
  Tᵣ ≡ {Pᵣ(f), [symbol]   (f)} ∀f. This is possible since face indices are
    contiguous and uniquely identify tree vertices.
  As a further optimization, entries with infinite weight (i.e., not
    part of tree) can be removed to compact the array,
    which requires the inclusion of the array index for
    parent vertex within each entry above. Noting that
    typically 2nₚ < 65536, a 16-bit array index and face
    index can be employed to save space.
Cluster index field, I(x′) . Optionally, compression can be
  performed profitably due to large constant regions over
  space.
Face cluster list, C. Because face clusters form a disjoint partition
  of all faces, the total size of this data is 2nₚ, and is thus light
  on storage.
```

### Example Processing Stages

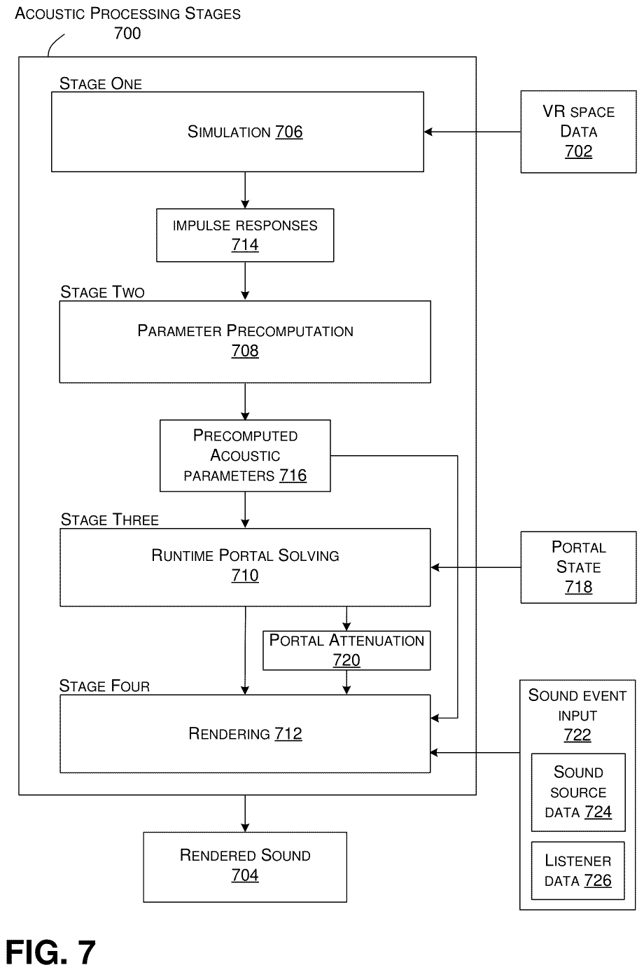

The above discussion provides various examples of how to determine acoustic portal parameters representing how sound energy propagation is influenced by portal state in a given scene, and how to employ those parameters at runtime to determine how much to attenuate a given sound. The following describes one approach for integrating the techniques described above into multiple acoustic processing stages 700, as illustrated in FIG. 7. In this example, acoustic processing stages can include Stages One, Two, Three, and Four. Generally speaking, the stages can receive virtual reality space data 702 representing virtual reality space (e.g., a video game, simulation, etc.) and ultimately produce a rendered sound 704 that realistically reflects the geometry of the virtual reality space.

The stages can be organized as follows, Stage One can relate to simulation 706, Stage Two can relate to parameter precomputation 708, Stage Three can relate to runtime portal solving 710, and Stage Four can relate to runtime sound rendering 712. Stage One and Stage Two can be implemented as precomputation steps, and Stages Three and Four can be performed at runtime. As discussed more below, the various stages can all be performed by the same entity or by a different entity, using a single application or multiple applications that perform different stages.

Turning first to Stage One, simulation 706 can be performed using virtual reality space data 702. The virtual reality space data can define the geometry of a virtual reality space, such as structures, materials of objects, location and dimension of portals, etc. For instance, the virtual reality space data 702 can include a voxel map that indicates which voxels in the three-dimensional space are occupied by geometry and which voxels are unoccupied. Simulation 706 can be implemented using a wave-based approach that involves generating directional impulse responses 714 reflecting travel from various source locations to various listener locations in the virtual scene. In some implementations, multiple simulations can be performed. For instance, a first simulation can be performed with each portal in a virtual scene treated as fully open and allowing sound to pass through the portals. A second simulation can be performed with each of the portals treated as fully closed and preventing sound from passing through the portals.

The impulse responses 714 can be input to Stage Two, which involves parameter precomputation 708. By analyzing the impulse responses, precomputed acoustic parameters 716 can be determined. One way to generate the precomputed acoustic parameters would be to generate directional impulse responses for every combination of possible source and listener locations (e.g., each voxel pair) and then precompute acoustic parameters for each voxel pair. While ensuring completeness, capturing the complexity of a virtual reality space in this manner can lead to generation of petabyte-scale wave fields. This can create a technical problem related to data processing and/or data storage. The techniques disclosed herein provide solutions for computationally efficient encoding and rendering using relatively compact representations.

As noted above, directional impulse responses 714 can be generated based on probes deployed at particular listener locations within the virtual reality space. Example probes are shown above in FIG. 1. This involves significantly less data storage than sampling at every potential listener location (e.g., every voxel). The probes can be automatically laid out within the virtual reality space and/or can be adaptively sampled. For instance, probes can be located more densely in spaces where scene geometry is locally complex (e.g., inside a narrow corridor with multiple portals), and located more sparsely in a wide-open space (e.g., outdoor field or meadow). In addition, vertical dimensions of the probes can be constrained to account for the height of human listeners, e.g., the probes may be instantiated with vertical dimensions that roughly account for the average height of a human being. Similarly, potential sound source locations for which directional impulse responses 714 are generated can be located more densely or sparsely as scene geometry permits. Reducing the number of locations within the virtual reality space for which the directional impulse responses 714 are generated can significantly reduce data processing and/or data storage expenses in Stage One.

In some implementations, parameter precomputation 708 can work cooperatively with simulation 706 to perform streaming encoding of the precomputed parameters. In this example, Stage Two can receive and compress individual directional impulse responses as they are being produced by simulation 706. For instance, values can be quantized and techniques such as delta encoding can be applied to the quantized values. Unlike directional impulse responses, this results in acoustic parameters that tend to be relatively smooth, which enables more compact compression using such techniques. Encoding parameters in this manner can significantly reduce storage expense.

The precomputed acoustic parameters 716 generally represent how sound from different source locations is perceived at different listener locations, as described in the '605 application and the '878 application. For example, the precomputed acoustic parameters for a given source/listener location pair can represent characteristics of coherent signals traveling from source locations to listener locations as well as characteristics of incoherent signals traveling from the source locations to the listener locations. Alternatively or additionally, the parameters can include as initial sound parameters such as an initial delay period, initial departure direction from the source location, initial arrival direction at the listener location, and/or initial loudness. The parameters for a given source/listener location pair can also include reflection parameters such as a reflection delay period and an aggregate representation of bidirectional reflection loudness, as well as reverberation parameters such as a decay time. Encoding precomputed acoustic parameters in this manner can yield a manageable data volume for the precomputed acoustic parameters, e.g., in a relatively compact data file that can later be used for computationally efficient rendering of sound. Some implementations can also encode frequency dependence of materials of a surface that affect the sound response when a sound hits the surface (e.g., changing properties of the resultant reflections).

In addition, the precomputed acoustic parameters 716 can include acoustic portal parameters representing how the sound energy propagation is impacted by the plurality of portals. These acoustic portal parameters can include a static energy field, a list of portal disks, a runtime portal graph, a cluster index field, and a face cluster list. Each of these acoustic portal parameters can be stored in association with a corresponding probed listener location.

At Stage Three, the precomputed acoustic parameters 716 (specifically the acoustic portal parameters relating to energy propagation through portals) can be input to runtime portal solving 710. In addition, the runtime portal solving can receive portal state 718. As described, the portal state can be provided as a vector of dynamic transmission losses at each portal face. In some cases, the transmission losses can be specified over different energy components, e.g., a component for dry or direct energy and another component for wet or reverberant energy. Stage Three can determine path-based portal attenuation values 720 for each component given the paths taken by the sound through various portals and the specified transmission losses. The static energy field and cluster index field can be interpolated based on probed listener locations that are adjacent to or nearby the runtime listener location.

The portal attenuation values can be input to Stage Four, which involves rendering 712. The rendering can collectively utilize the precomputed acoustic parameters 716 and the portal attenuation values 720 to render sound in the virtual reality space based on a received sound event input 722. As mentioned above, the precomputed acoustic parameters 716 can be obtained in advance and stored, such as in the form of a compressed data file.

In general, the sound event input 722 shown in FIG. 7 can be related to any event in the virtual reality space that creates a sound. The sound event input 722 can include sound source data 724 for a given sound event, e.g., an input sound signal for a runtime sound source and a location of the runtime sound source. For clarity, the term “runtime sound source” is used to refer to the sound source being rendered, to distinguish the runtime sound source from sound sources discussed above with respect to simulation and encoding of parameters. The sound source data can also convey directional characteristics of the runtime sound source.

The sound input event input 722 can also include listener data 726, which can convey a location of a runtime listener. The term “runtime listener” is used to refer to the listener of the rendered sound at runtime, to distinguish the runtime listener from listeners discussed above with respect to simulation and encoding of parameters. The listener data can also convey directional hearing characteristics of the listener, e.g., in the form of a head-related transfer function (HRTF).

In some implementations, sounds can be rendered using a lightweight signal processing algorithm. The lightweight signal processing algorithm can render sound in a manner that can be largely computationally cost-insensitive to a number of the sound sources and/or sound events. For example, the parameters can be selected such that the number of sound sources processed in Stage Four does not linearly increase processing expense. The sound source data for the input event can include an input signal, e.g., a time-domain representation of a sound such as series of samples of signal amplitude (e.g., 44100 samples per second). The input signal can have multiple frequency components and corresponding magnitudes and phases. The rendering can involve applying a gain to the sound signal where gain is based on the path-based attenuation values received from Stage Four. As noted, in some cases, different path-based attenuations are determined for different (e.g., wet and dry) components of the sound signal. Thus, different gains can be applied for the different components when rendering the sound. Additional details on rendering can be found in the '605 application and the '878 application.

### Applications

The acoustic processing stages 700 mentioned above can operate on many different types of virtual reality spaces. For instance, the virtual reality space data 702 can represent a video game where they dynamic portals include windows, doors, or destructible portions of the scene that can vary during gameplay. As another example, the virtual reality space data can correspond to a simulation, e.g., a training simulation for firefighters to navigate floors of a virtual building to extinguish a fire.

As another example, the virtual reality space can represent a virtual conference room that mirrors a real-world conference room. For example, live attendees could be coming and going from the real-world conference room, while remote attendees log in and out. In this example, the voice of a particular live attendee, as rendered in the headset of a remote attendee, could fade away as a door closes behind a live attendee walking out of the real-world conference room.

In other implementations, animation can be viewed as a type of virtual reality scenario. In this case, the acoustic processing stages 700 can be paired with an animation process, such as for production of an animated movie. For instance, as visual frames of an animated movie are generated, virtual reality space data 702 could include geometry of the animated scene depicted in the visual frames. A listener location could be an estimated audience location for viewing the animation. Sound source event input 722 could include information related to sounds produced by animated subjects and/or objects. In this instance, the acoustic processing stages can be performed cooperatively with an animation system to model and/or render sound to accompany the visual frames.

In another implementation, the disclosed concepts can be used to complement visual special effects in live action movies. For example, virtual content can be added to real world video images. In one case, a real-world video can be captured of a city scene. In post-production, virtual image content can be added to the real-world video, such as an animated character playing a trombone in the real-world scene. By representing the real-world city scene as a virtual space and determining sound characteristics of the trombone, sound can be rendered that accounts for one or more physical doors or windows opening and/or closing along one or more paths from the trombone player to the audience.

Overall, the acoustic processing stages 700 can model acoustic effects for arbitrarily moving listener and/or sound sources that can emit any sound signal. The result can be a practical system that can render convincing audio in real-time for scenes with one or more dynamic portals. Furthermore, these techniques can render convincing audio for complex scenes while solving a previously intractable technical problem of processing petabyte-scale wave fields. As such, the techniques disclosed herein can handle be used to render sound for complex 3D scenes with dynamic source locations, dynamic listener locations, and dynamic portal states. The result can be a practical system that can produce convincing sound for video games and/or other virtual reality scenarios in real-time.

As related point, note that the acoustic portal parameters disclosed herein can also be employed in other types of systems that do not necessarily rely on precomputation of other acoustic parameters. For instance, raytracing approaches can also be augmented using path-based attenuation according to the disclosed techniques to adjust sound in response to changing portal state.

### Example System

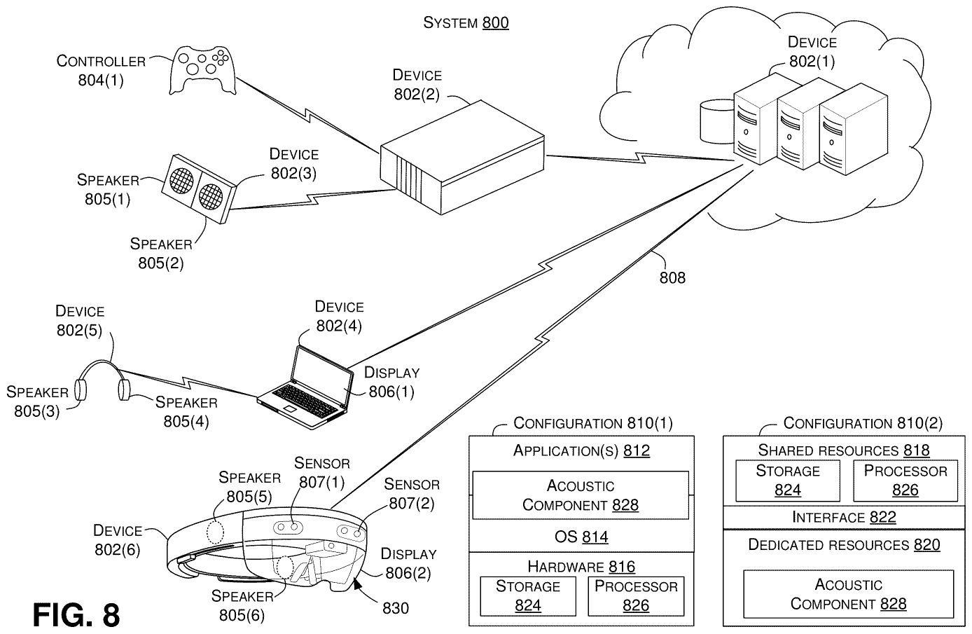

FIG. 8 shows a system 800 in which the disclosed concepts can be implemented. For purposes of explanation, system 800 can include device 802(1), device 802(2), device 802(3), device 802(4), device 802(5), and device 802(6). The devices may interact with and/or include controller 804(1) (e.g., one or more input devices), speaker 805(1), speaker 805(2), speaker 805(3), speaker 805(4), speaker 805(5), speaker 805(6), display 806(1), display 806(2), sensor 807(1), and/or sensor 807(2). The sensors can be implemented as various 2D, 3D, and/or microelectromechanical systems (MEMS) devices. The devices, controllers, speakers, displays, and/or sensors can communicate via one or more networks (represented by lightning bolts 808).

In the illustrated example, example device 802(1) is manifest as a server device, example device 802(2) is manifest as a gaming console device, example device 802(3) is manifest as a speaker set, example device 802(4) is manifest as a notebook computer, example device 802(5) is manifest as headphones, and example device 802(6) is manifest as a virtual reality device such as a head-mounted display (HMD) device. While specific device examples are illustrated for purposes of explanation, devices can be manifest in any of a myriad of ever-evolving or yet to be developed types of devices.

In one configuration, device 802(2) and device 802(3) can be proximate to one another, such as in a home video game type scenario. In other configurations, devices can be remote from one another. For example, device 802(1) can be in a server farm and can receive and/or transmit data related to the concepts disclosed herein.

FIG. 8 shows two device configurations that can be employed by various devices. Individual devices can employ either configuration 810(1), configuration 810(2), or an alternate configuration. (Due to space constraints on the drawing page, one instance of each device configuration is illustrated rather than illustrating the device configurations relative to each device.) Briefly, device configuration 810(1) represents an operating system (OS) centric configuration. Device configuration 810(2) represents a system on a chip (SOC) configuration. Device configuration 810(1) is organized into one or more application(s) 812, operating system 814, and hardware 816. Device configuration 810(2) is organized into shared resources 818, dedicated resources 820, and an interface 822 there between.

In either configuration, a device can include storage/memory 824, a processor 826, and/or an acoustic component 828. The acoustic component 828 can implement any or all of the acoustic processing stages 700 introduced above relative to FIG. 7. In some configurations, each of devices can have an instance of the acoustic component 828. However, the functionalities that can be performed by acoustic component 828 may be the same or they may be different from one another. In some cases, each device's acoustic component 828 can be robust and provide all of the functionality described above and below (e.g., a device-centric implementation). In other cases, some devices can employ a less robust instance of the acoustic component that relies on some functionality to be performed remotely. For instance, the acoustic component 828 on device 802(1) can perform functionality related to Stages One and Two, described above for a given application, such as a video game or virtual reality application. In this instance, the acoustic component 828 on device 802(2) can communicate with device 802(1) to receive precomputed acoustic parameters 716. The acoustic component 828 on device 802(2) can perform Stages Three and Four, by utilizing the precomputed parameters with sound event inputs and portal state information to produce rendered sound 704, which can be played by speakers 805(1) and 805(2) for the user. As another example, in some implementations one acoustic component can implement the base solver described above, another acoustic component on a second device can implement the portal solver described above, and a third acoustic component can implement the rendering described above.

In the example of device 802(6), the sensors can provide information about the location and/or orientation of a user of the device (e.g., the user's head and/or eyes relative to visual content presented on the display 806(2)). The location and/or orientation can be used for rendering sounds to the user by treating the user as a listener or, in some cases, as a sound source. In device 802(6), a visual representation 830 (e.g., visual content, graphical use interface) can be presented on display 806(2). In some cases, the visual representation can be based at least in part on the information about the location and/or orientation of the user provided by the sensors. Also, the acoustic component 828 on device 802(6) can receive precomputed acoustic parameters from device 802(1). In this case, the acoustic component 828(6) can produce rendered sound that has accurate directionality in accordance with the representation, accounting for portal state on a path from a sound source to a listener location. Stated another way, stereoscopic sound can be rendered through the speakers 805(5) and 805(6) in proper orientation to a visual scene or environment and modified according to the state of various portals within the scene, to provide convincing sound to enhance the user experience.

In still another case, Stages One and Two described above can be performed responsively to inputs provided by a video game and/or virtual reality application. The output of these stages, e.g., precomputed acoustic parameters 716, can be added to the video game as a plugin that also contains code for Stage Three. At runtime, when a sound event occurs, the plugin can apply the precomputed parameters (as well as first parameters) to the sound event to compute the corresponding rendered sound for the sound event. In other implementations, the video game and/or virtual reality application can provide sound event inputs to a separate rendering component (e.g., provided by an operating system) that renders sound on behalf of the video game and/or virtual reality application.

In some cases, the disclosed implementations can be provided by a plugin for an application development environment. For instance, an application development environment can provide various tools for developing video games, virtual reality applications, and/or architectural walkthrough applications. These tools can be augmented by a plugin that implements one or more of the stages discussed above. For instance, in some cases, an application developer can provide a description of a scene to the plugin and the plugin can perform the disclosed simulation techniques on a local or remote device, and output encoded precomputed parameters for the scene. In addition, the plugin can implement scene-specific rendering given an input sound signal and information about source and listener locations/orientations. In other cases, the plugin can receive portal attenuation values, source, and listener locations, and output path-based attenuation that can be employed by the application to adjust the sound signal.

### Precomputation Method

Detailed example implementations of simulation and parameter precomputation concepts have been provided above. The example method provided in this section summarizes these concepts.

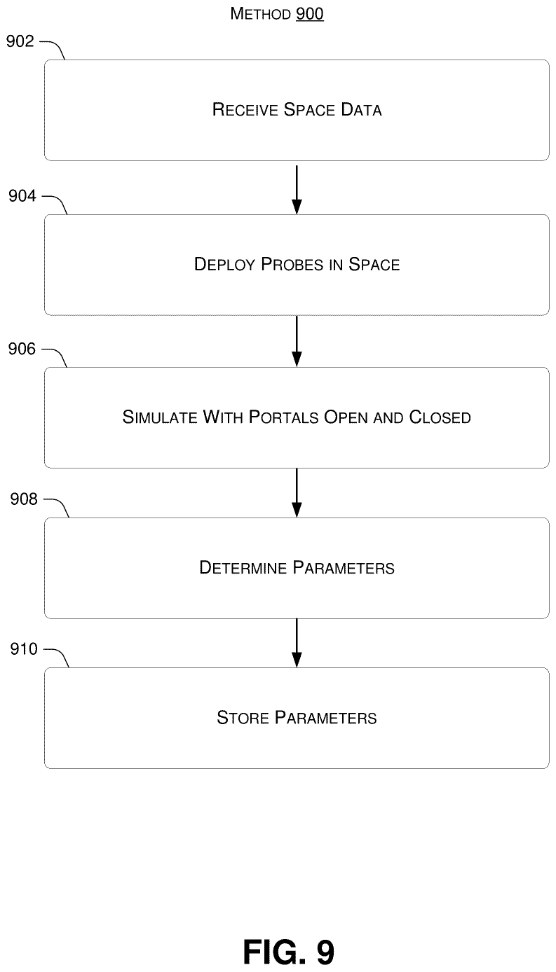

As shown in FIG. 9, at block 902, method 900 can receive virtual reality space data corresponding to a virtual reality space. In some cases, the virtual reality space data can include a geometry of the virtual reality space. For instance, the virtual reality space data can describe structures, such as surface(s) and/or portal(s). The virtual reality space data can also include additional information related to the geometry, such as surface texture, material, thickness, etc. In addition, the virtual reality space data can identify the location, size, shape, etc., of various portals in the scene.

At block 904, method 900 can deploy probes in the space. Each probe corresponds to a potential listener location. The probes can be located within a given voxel on a voxel grid representing the scene.

At block 906, method 900 can simulate sound propagation in the space from various sound source locations to each probed listener location. The simulations can include a first simulation performed with all of the portals closed (assuming the portals fully block any sound when closed) and a second simulation with all of the portals fully open. This approach can generate directional impulse responses for the virtual reality space. In some cases, method 900 can generate the directional impulse responses by simulating initial sounds emanating from multiple moving sound sources and/or arriving at multiple moving listeners, e.g., using a wave solver to derive parameters.

At block 908, various acoustic parameters can be determined. For instance, the acoustic parameters can include acoustic portal parameters that model acoustic propagation according to dynamic portal state, such as a static energy field, a list of portal disks, a portal graph, a cluster index field, and a face cluster list for each probed listener location. Other parameters can be used to model coherent, incoherent, initial, reflected, and/or reverberant sound, as described in the '605 application and the '878 application.

At block 910, method 900 can store the parameters on a storage device. The parameters can be subsequently used as a basis to account for dynamic portal state when rendering sound within the scene, e.g., by attenuating runtime sound traveling through one or more portals from a sound source to a listener. Method 900 can be performed by implementing Stages One and Two from acoustic processing stages 700.

### Runtime Method

Detailed example implementations portal solving and rendering concepts have been provided above. The example method provided in this section summarizes these concepts.

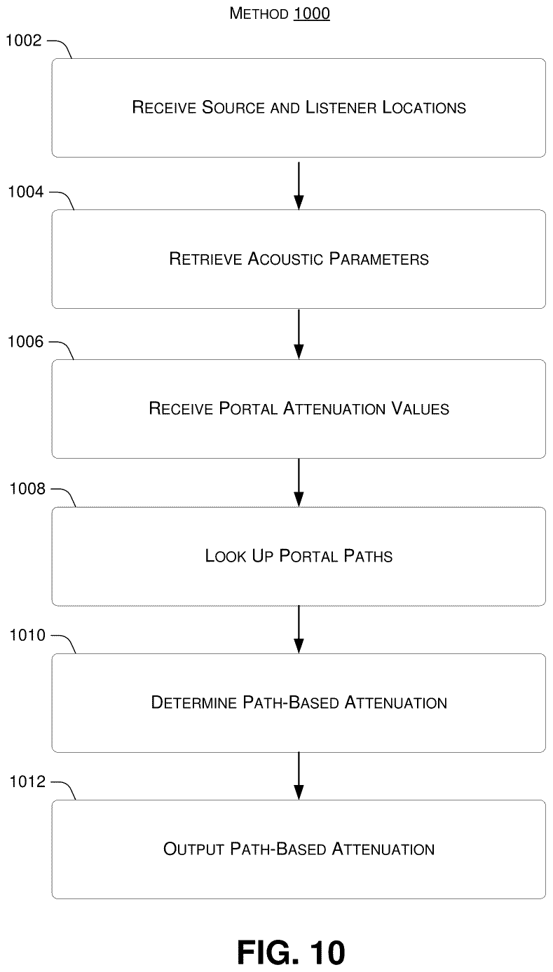

As shown in FIG. 10, at block 1002, method 1000 can receive a source location and a listener location, where the source location corresponds to a sound source that emits a sound signal to the listener location in the scene. The scene can have a plurality of portals.

At block 1004, method 1000 can retrieve acoustic parameters based on the listener location and/or source location. For instance, the acoustic parameters can include acoustic portal parameters such a static energy field, a list of portal disks, a portal graph, a cluster index field, and a face cluster list. The acoustic parameters can also include parameters that can be used to model coherent, incoherent, initial, reflected, and/or reverberant sound, as described in the '605 application and the '878 application.

At block 1006, method 1000 can receive portal attenuation values for portals in the scene. For instance, the portal attenuation values can correspond to transmission loss factors as described above. In some implementations, the portal attenuation values can specify different losses across each portal for different components of the sound signal, e.g., wet vs. dry energy, different frequency components, etc.

At block 1008, method 1000 can look up portal paths in the acoustic portal parameters. For instance, the portal paths can be looked up in a runtime portal graph, as described above.

At block 1010, method 1000 can determine path-based attenuation accounting for the portal state. For instance, the path-based attenuation can be calculated as described above. The path-based attenuation can be aggregated over each of multiple portal paths from the source location to the listener location.

At block 1012, method 1000 can output the path-based attenuation. For instance, the path-based attenuation can be provided to a video game or other application to render sound by applying a gain to a sound signal based on the path-based attenuation. In some cases, block 1012 can involve determining different path-based attenuations for different components of the sound signal (e.g., wet and dry components).

Method 1000 can be performed by implementing Stage Three from acoustic processing stages 700. Subsequently, sound can be rendered at the listener location by performing Stage Four, which can involve applying different gains to the different components, where the gains are based on the path-based attenuations.

### Device Implementations

The term “device,” “computer,” or “computing device” as used herein can mean any type of device that has some amount of processing capability and/or storage capability. Processing capability can be provided by one or more processors that can execute computer-readable instructions to provide functionality. Data and/or computer-readable instructions can be stored on storage, such as storage that can be internal or external to the device. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among types of storage medium.

As mentioned above, device configuration 810(2) can be thought of as a system on a chip (SOC) type design. In such a case, functionality provided by the device can be integrated on a single SOC or multiple coupled SOCs. One or more processors 826 can be configured to coordinate with shared resources 818, such as storage/memory 824, etc., and/or one or more dedicated resources 820, such as hardware blocks configured to perform certain specific functionality. Thus, the term “processor” as used herein can also refer to central processing units (CPUs), graphical processing units (GPUs), field programmable gate arrays (FPGAs), controllers, microcontrollers, processor cores, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU or CPUs). The program code can be stored in one or more computer-readable memory devices, such as computer-readable storage media. The features and techniques of the component are platform-independent, meaning that they may be implemented on a variety of commercial computing platforms having a variety of processing configurations.

### Additional Examples

Various device examples are described above. Additional examples are described below. One example includes a method comprising receiving space data characterizing a virtual scene that includes a plurality of portals, deploying probes at listener locations in the virtual scene, simulating sound energy propagation within the virtual scene from various source locations to the probes at the listener locations, the simulating being performed with the plurality of portals in at least two different states, determining acoustic portal parameters representing how the sound energy propagation is impacted by the plurality of portals in the at least two different states, and storing the acoustic portal parameters, the acoustic parameters providing a basis for attenuating runtime sound in the virtual scene according to sound attenuation by individual portals.

Another example can include any of the above and/or below examples where the simulating comprises performing a first simulation with each of the portals in a fully open state that allows sound to pass through the portals and performing a second simulation with each of the portals in a fully closed state that prevents sound from passing through the portals.

Another example can include any of the above and/or below examples where the acoustic portal parameters include a static energy field for each probe.

Another example can include any of the above and/or below examples where the static energy field comprises a ratio of total energy arriving at each probe during the second simulation over total energy arriving at each probe during the first simulation.

Another example can include any of the above and/or below examples where the acoustic portal parameters include a list of portal disks.

Another example can include any of the above and/or below examples where the acoustic portal parameters include a runtime portal graph.

Another example can include any of the above and/or below examples where the acoustic portal parameters include a cluster index field.

Another example can include any of the above and/or below examples where the acoustic portal parameters include a face cluster list.

Another example includes a method comprising receiving a source location of a sound source that emits a sound signal to a listener location of a listener in a scene having a plurality of portals, retrieving acoustic portal parameters for the listener location, the acoustic portal parameters representing how sound energy propagation arriving at the listener location is impacted by the plurality of portals, receiving portal attenuation values for the plurality of portals in the scene, looking up portal paths in the acoustic portal parameters based at least on the listener location, determining a path-based attenuation from the source location to the listener location along the portal paths according to the acoustic portal parameters and the portal attenuation values, and outputting the path-based attenuation.

Another example can include any of the above and/or below examples where the acoustic portal parameters include a static energy field, a list of portal disks, a runtime portal graph, a cluster index field, and a face cluster list.

Another example can include any of the above and/or below examples where the portal paths are looked up in the runtime portal graph based at least on the sound source location.

Another example can include any of the above and/or below examples where the portal paths include multiple portal paths through different sets of portals, and the path-based attenuation is aggregated over each of the multiple portal paths.

Another example can include any of the above and/or below examples where the method further comprises rendering a sound at the listener location based at least on the path-based attenuation.

Another example can include any of the above and/or below examples where the method further comprises determining different path-based attenuations for different components of the sound signal and rendering the sound at the listener location according to the different components.

Another example can include any of the above and/or below examples where the different components include dry sound and wet sound.

Another example includes a system comprising a processor and a storage medium storing instructions which, when executed by the processor, cause the system to receive a source location of a sound source that emits a sound signal to a listener location of a listener in a scene having a plurality of portals, retrieve acoustic portal parameters for the listener location, the acoustic portal parameters representing how sound energy propagation arriving at the listener location is impacted by the plurality of portals, receive portal attenuation values for the plurality of portals in the scene, look up portal paths in the acoustic portal parameters based at least on the listener location, determine a path-based attenuation from the source location to the listener location along the portal paths according to the acoustic portal parameters and the portal attenuation values, and output the path-based attenuation.

Another example can include any of the above and/or below examples where the instructions, when executed by the processor, cause the system to render a sound at the listener location based at least on the path-based attenuation.

Another example can include any of the above and/or below examples where the portal paths are looked up in a runtime portal graph based at least on the sound source location.

Another example can include any of the above and/or below examples where the portal paths include multiple portal paths through different sets of portals, and wherein the path-based attenuation is aggregated over each of the multiple portal paths.

Another example can include any of the above and/or below examples where the instructions, when executed by the processor, cause the system to determine different path-based attenuations for dry and wet components of the sound signal and render the sound at the listener location according to the different path-based attenuations for the dry and wet components.

### CONCLUSION

The methods described above and below can be performed by the systems and/or devices described above, and/or by other devices and/or systems. The order in which the methods are described is not intended to be construed as a limitation, and any number of the described acts can be combined in any order to implement the methods, or an alternate method(s). Furthermore, the methods can be implemented in any suitable hardware, software, firmware, or combination thereof, such that a device can implement the methods. In one case, the method or methods are stored on computer-readable storage media as a set of computer-readable instructions such that execution by a computing device causes the computing device to perform the method(s).

Although techniques, methods, devices, systems, etc., are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A method comprising:
receiving space data characterizing a virtual scene that includes a plurality of portals;
deploying probes at listener locations in the virtual scene;
simulating sound energy propagation within the virtual scene from various source locations to the probes at the listener locations, the simulating being performed with the plurality of portals in at least two different states;
determining acoustic portal parameters representing how the sound energy propagation is impacted by the plurality of portals in the at least two different states; and
storing the acoustic portal parameters, the acoustic parameters providing a basis for attenuating runtime sound in the virtual scene according to sound attenuation by individual portals.

2. The method of claim 1, wherein the simulating comprises:
performing a first simulation with each of the portals in a fully open state that allows sound to pass through the portals; and
performing a second simulation with each of the portals in a fully closed state that prevents sound from passing through the portals.

3. The method of claim 2, wherein the acoustic portal parameters include a static energy field for each probe.

4. The method of claim 3, wherein the static energy field comprises a ratio of total energy arriving at each probe during the second simulation over total energy arriving at each probe during the first simulation.

5. The method of claim 4, wherein the acoustic portal parameters include a list of portal disks.

6. The method of claim 5, wherein the acoustic portal parameters include a runtime portal graph.

7. The method of claim 6, wherein the acoustic portal parameters include a cluster index field.

8. The method of claim 7, wherein the acoustic portal parameters include a face cluster list.

9. A method comprising:
receiving a source location of a sound source that emits a sound signal to a listener location of a listener in a scene having a plurality of portals;
retrieving acoustic portal parameters for the listener location, the acoustic portal parameters representing how sound energy propagation arriving at the listener location is impacted by the plurality of portals;
receiving portal attenuation values for the plurality of portals in the scene;
looking up portal paths in the acoustic portal parameters based at least on the listener location;
determining a path-based attenuation from the source location to the listener location along the portal paths according to the acoustic portal parameters and the portal attenuation values; and
outputting the path-based attenuation.

10. The method of claim 9, wherein the acoustic portal parameters include:
a static energy field,
a list of portal disks,
a runtime portal graph,
a cluster index field, and
a face cluster list.

11. The method of claim 10, wherein the portal paths are looked up in the runtime portal graph based at least on the sound source location.

12. The method of claim 11, wherein the portal paths include multiple portal paths through different sets of portals, and the path-based attenuation is aggregated over each of the multiple portal paths.

13. The method of claim 9, further comprising:
rendering a sound at the listener location based at least on the path-based attenuation.

14. The method of claim 13, further comprising:
determining different path-based attenuations for different components of the sound signal; and
rendering the sound at the listener location according to the different components.

15. The method of claim 14, the different components including dry sound and wet sound.

16. A system comprising:
a processor; and
a storage medium storing instructions which, when executed by the processor, cause the system to:
receive a source location of a sound source that emits a sound signal to a listener location of a listener in a scene having a plurality of portals;
retrieve acoustic portal parameters for the listener location, the acoustic portal parameters representing how sound energy propagation arriving at the listener location is impacted by the plurality of portals;
receive portal attenuation values for the plurality of portals in the scene;
look up portal paths in the acoustic portal parameters based at least on the listener location;
determine a path-based attenuation from the source location to the listener location along the portal paths according to the acoustic portal parameters and the portal attenuation values; and
output the path-based attenuation.

17. The system of claim 16, wherein the instructions, when executed by the processor, cause the system to:
render a sound at the listener location based at least on the path-based attenuation.

18. The system of claim 17, wherein the portal paths are looked up in a runtime portal graph based at least on the sound source location.

19. The system of claim 18, wherein the portal paths include multiple portal paths through different sets of portals, and wherein the path-based attenuation is aggregated over each of the multiple portal paths.

20. The system of claim 19, wherein the instructions, when executed by the processor, cause the system to:
determine different path-based attenuations for dry and wet components of the sound signal; and
render the sound at the listener location according to the different path-based attenuations for the dry and wet components.
